(19) United States
(12) Patent Application Publication
(10) Pub. No.: US 2009/0294203 A1
(43) Pub. Date: Dec. 3, 2009

(54) electric power steering apparatus

(75) Inventors: Jun Okada, Gunma (JP); Osamu Tatewaki, Gunma (JP); Osamu Saito, Gunma (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 11/659,483

(22) PCT Filed: Aug. 5, 2005
(86) PCT No.: PCT/JP2005/014438

§ 371 Date: Mar. 6, 2009

(30) Foreign Application Priority Data
Aug. 6, 2004 (JP) 2004-230854
Aug. 6, 2004 (JP) 2004-230855
Jan. 14, 2005 (JP) 2005-007759
Jan. 18, 2005 (JP) 2005-009877
Jan. 18, 2005 (JP) 2005-009878
Jan. 18, 2005 (JP) 2005-009882
Jan. 18, 2005 (JP) 2005-119883
Feb. 24, 2005 (JP) 2005-048614

(51) Int. Cl. B62D 5/04

(52) U.S. Cl. 180/444

(57) ABSTRACT

Deflectors (45b) of a nut (45) pick up balls (65) from a rolling passage (23b, 45f) in a tangential direction of the rolling passage and also in a direction of a lead angle thereof, and therefore the balls (65) can be picked up into a circulating passage (45c) without changing a direction of rolling of the balls, and therefore the smooth rolling can be secured, and operating sounds, vibrations, etc., can be kept to a low level.

### TECHNICAL FIELD

This invention relates to an electric power steering apparatus provided with a ball screw mechanism.

### BACKGROUND ART

There is known an electric power steering apparatus in which an electric motor is driven in accordance with a steering torque, and a rotational force of this electric motor is transmitted by transmitting this rotation force to a rack shaft so as to assist a steering operation. Here, in some cases, a ball screw mechanism is used in order to convert the rotational force of the electric motor into a thrust of the rack shaft (See JP-B-6-504 Publication).

Incidentally, in an electric power steering apparatus described in JP-B-6-504 Publication, a gear is formed integrally on an outer periphery of a nut of the ball screw mechanism, and power of the electric motor is transmitted to the nut via this gear. Therefore, in order to achieve a high-speed rotation of the nut, it is desired to suppress its inertia. Also, it is desired to keep an external form of the electric power steering apparatus to a small size, and for achieving this, it is preferred to make an outer diameter of the nut smaller.

On the other hand, in an electric power steering apparatus described in JP-A-2000-225956 Publication, end caps for ball circulating purposes are attached respectively to opposite ends of a nut of a ball screw mechanism.

A schematic cross-sectional view of this conventional ball screw mechanism is shown in FIG. 9. As shown in the Figure, in the case of the end cap-type, end surfaces of the nut N are completely covered with the end caps ED, and therefore in the case of transmitting power to the nut N in an axial direction for power transmitting purposes, when the power transmission is effected via the end cap ED, an internal circulating passage is distorted by stresses due to the power transmission, and there are fears that the proper ball circulation can not be effected and that the end cap ED is broken. However, when the rigidity of the end cap ED is increased by increasing its thickness, the nut N becomes large and heavy, so that an inertia force which adversely affects an assist control increases, and therefore this is not desirable.

On the other hand, it can be thought that a flange F having an outer diameter larger than the end cap ED is formed on the nut N so that the power transmission can be effected via this flange F. However, this incurs a large-size design of the apparatus. On the one hand, when there is employed a tube or a piece commonly used for ball circulating purposes, the power transmission can be effected via the nut end surface, but there is a problem that the outer diameter of the nut becomes large.

Further, in the electric power steering apparatus described in JP-B-6-504 Publication, the gear is formed integrally on the outer periphery of the nut of the ball screw mechanism, and power of the electric motor is transmitted to the nut via this gear. Therefore, when the nut and a screw shaft rotate relative to each other, a circulating passage for returning balls from one end of a rolling passage to the other end thereof is required, but the circulating passage is not disclosed at all in JP-B-6-504 Publication. Therefore, it is thought that a tube or a piece which is an ordinary circulating passage is used. However, in the case where the gear is formed on the outer periphery of the nut, it is difficult to provide the tube or the piece astride the gear. Therefore, in the electric power steering apparatus disclosed in JP-B-6-504 Publication, despite the drawings of JP-B-6-504 Publication, it should be thought that the gear of the nut is disposed to be offset outwardly of the rolling passage in the axial direction.

Therefore, considering that the gear of the nut is disposed to be offset outwardly of the rolling passage in the axial direction, a torque transmitted from the electric motor is inputted to one end of the nut, and therefore the nut is liable to be wrenched, so that the smooth power transmission can not be effected. And besides, in the case of transmitting a large torque, a tooth width of the gear must be increased in order to decrease a contact pressure of a tooth face, but this increases the axial length of the nut, thus inviting a problem that the compact design of the electric power steering apparatus can not be achieved.

### DISCLOSURE OF THE INVENTION

The present invention has been made in view of the above problems of the conventional techniques, and its object is to provide an electric power steering apparatus which can secure a smooth operation while achieving a compact design.

According to the present invention, there is provided an electric power steering apparatus comprising:

an electric motor;

a rack shaft connected to a steering mechanism; and

a power transmission mechanism for transmitting power from the electric motor to the rack shaft, and the power transmission mechanism comprising:

a screw shaft which is connected to or formed integrally with the rack shaft, and has a male screw groove;

a nut which is disposed on a periphery of the screw shaft, and has a female screw groove; and

a plurality of rolling members which can roll in a rolling passage formed between the male screw groove and the female screw groove, wherein

the nut comprises:
a body having an axially-extending circulating passage for the rolling members, and
deflectors which are provided respectively at opposite ends of the body, and pick up the rolling members, rolling in the rolling passage, in a tangential direction of the rolling passage and also in a direction of a lead angle thereof to return the rolling members to the circulating passage.

According to the present invention, there is provided an electric power steering apparatus comprising:

an electric motor;

a rack shaft connected to a steering mechanism; and

a power transmission mechanism for transmitting power from the electric motor to the rack shaft, and the power transmission mechanism comprising:
a screw shaft which is connected to or formed integrally with the rack shaft, and has a male screw groove;
a nut which is disposed on a periphery of the screw shaft, and has a female screw groove;
a plurality of rolling members which can roll in a rolling passage formed between the male screw groove and the female screw groove, and a sleeve having a reception portion for receiving power transmitted from the electric motor, wherein

the nut is inserted in and fixed to the sleeve with the reception portion disposed radially outwardly of the rolling passage, and rotate together with the sleeve.

According to the present invention, there is provided an electric power steering apparatus comprising:

an electric motor;

a rack shaft connected to a steering mechanism; and

a power transmission mechanism for transmitting power from the electric motor to the rack shaft, and the power transmission mechanism comprising:
a screw shaft which is connected to or formed integrally with the rack shaft, and has a male screw groove;
a nut which is disposed on a periphery of the screw shaft, and has a female screw groove; and
a plurality of rolling members which can roll in a rolling passage formed between the male screw groove and the female screw groove, wherein

the nut comprises a body having an axially-extending circulating passage for the rolling members; and

deflectors which are provided respectively at opposite ends of the body, and pick up the rolling members, rolling in the rolling passage, in a tangential direction of the rolling passage and also in a direction of a lead angle thereof to return the rolling members to the circulating passage,

wherein power of the electric motor is transmitted to the nut via a fixing member fixing the deflector to the nut.

According to the present invention, there is provided an electric power steering apparatus comprising:

an electric motor;

a rack shaft connected to a steering mechanism; and

a power transmission mechanism for transmitting power from the electric motor to the rack shaft, and the power transmission mechanism comprising:
a screw shaft which is connected to or formed integrally with the rack shaft, and has a male screw groove,
a nut which is disposed on a periphery of the screw shaft, and has a female screw groove, and
a plurality of rolling members which roll in a rolling passage formed between the male screw groove and the female screw groove, wherein

the nut comprises:
a body having an axially-extending circulating passage for the rolling members; and
deflectors which are provided respectively at opposite ends of the body, and pick up the rolling members, rolling in the rolling passage, in a tangential direction of the rolling passage and also in a direction of a lead angle thereof to return the rolling members to the circulating passage,

the deflector is mounted on the nut by fastening means fixing a bearing supporting the nut.

According to the present invention, there is provided an electric power steering apparatus comprising:

an electric motor;

a rack shaft connected to a steering mechanism; and

a power transmission mechanism for transmitting power from the electric motor to the rack shaft, and the power transmission mechanism comprising:
a screw shaft which is connected to or formed integrally with the rack shaft, and has a male screw groove;
a nut which is disposed on a periphery of the screw shaft, and has a female screw groove; and
a plurality of rolling members which roll in a rolling passage formed between the male screw groove and the female screw groove, wherein

the nut comprises:
a body having an axially-extending circulating passage for the rolling members; and
deflectors which are provided respectively at opposite ends of the body, and pick up the rolling members, rolling in the rolling passage, in a tangential direction of the rolling passage and also in a direction of a lead angle thereof to return the rolling members to the circulating passage, and

projections extending from an axially-facing end surface of the body at least in the axial direction or recesses indented from the end surface in the axial direction are formed at the end surface in order to transmit the power of the electric motor.

In the electric power steering apparatus of the present invention, the nut has the deflectors which are provided respectively at the opposite ends of the body, and pick up the rolling members, rolling in the rolling passage, in the tangential direction of the rolling passage and also in the direction of the lead angle thereof to return the rolling members to the circulating passage, and therefore the rolling members can be picked up without changing the direction of rolling of the rolling members, and therefore the smooth rolling can be effected, and operating sounds, vibrations, etc., can be kept to a low level. Particularly, thanks to the provision of the deflectors, it is not necessary to provide a conventional piece, a conventional tube or the like on the outer peripheral surface of the nut, and therefore the outer diameter of the nut can be kept to a small size. And besides, as compared with an end cap-type, the axial length of the nut can be kept to a short size.

Preferably, the nut has a reception portion for receiving power transmitted from the electric motor which reception portion is disposed radially outwardly of the rolling passage.

Preferably, the reception portion is a gear portion formed on the outer peripheral surface of the nut, and power from the electric motor is transmitted via another gear in mesh with this gear portion; however, the power may be transmitted via a toothed belt or a chain engaged with the gear portion.

In case the deflector is fixed to the nut, using an annular fixing member press-fitted in the nut, and the fixing member has a female serration portion engaged with a male serration portion of an external member, and the power transmission is effected via the male serration portion and the female serration portion engaged with each other, the power transmission can be effected without increasing the outer diameter of the nut, and therefore this is preferable.

In the electric power steering apparatus of the present invention, the nut is inserted in and fixed to the sleeve so as to rotate in unison therewith, and therefore regardless of the shape of the outer peripheral surface of the nut, the reception portion for receiving power transmitted from the electric motor can be provided at the outer peripheral surface or other portion of the sleeve disposed radially outwardly of the rolling passage, and therefore when power from the electric motor is transmitted to the reception portion, the wrenching of the nut is suppressed, thereby enabling the smooth operation. And besides, by providing the reception portion for receiving power transmitted from the electric motor at the outer peripheral surface or other portion disposed radially outwardly of the rolling passage, the axial length of each of the sleeve and the nut can be kept to a short size. Furthermore, the nut having the female screw groove formed therein is inserted in and fixed to the sleeve having the reception portion thereon, and therefore the two can be processed separately from each other, and therefore the production cost can be reduced.

Preferably, the nut comprises a body having an axially-extending circulating passage for the rolling members, and deflectors which are provided respectively at opposite ends of the body, and pick up the rolling members, rolling in the rolling passage, in the tangential direction of the rolling passage and also in the direction of the lead angle thereof to return the rolling members to the circulating passage.

For example, in a conventional technique described in JP-A-2004-176826, instead of using a circulating member, an axial groove is formed in an outer periphery of a nut, and further grooves which connect this axial groove to a spiral groove in the inner side of the nut are formed respectively in opposite end surfaces. However, with this connection construction, a direction of rolling of balls is greatly changed at the time when the balls are moved from the spiral groove to the axial groove, and therefore the movement of the balls can be effected smoothly, and there is a fear that the operation may be worsened. And besides, the groove shape is complicated, and therefore the time required for the processing increases, thus incurring the cost increase.

On the other hand, in the present invention, the deflectors are provided respectively at the opposite ends of the body, and pickup the balls, rolling in the rolling passage, in the tangential direction of the rolling passage and also in the direction of the lead angle thereof to return the balls to the circulating passage, and therefore the circulation of the balls can be effected while keeping a gap between the ball and the circulating passage to an optimum value, and besides the changing of the direction of rolling of the rolling members can be suppressed, and therefore the rolling of the balls becomes smooth, and the operation becomes good. Furthermore, the deflectors can be provided in the form separate from the nut, and therefore the processing of the nut becomes easy.

Incidentally, by providing the deflectors instead of a tube or a piece, teeth such as serrations can be formed at the outer peripheral surface of the nut, and therefore the fitting and fixing thereof relative to the sleeve becomes easy; however, the nut may be of the type having end caps. Furthermore, even the type of nut having a piece or a tube can be used in so far as it can be fitted in and fixed to the sleeve.

Preferably, the nut is fitted in and fixed to the sleeve.

Preferably, the nut is serration connected to the sleeve.

Preferably, an elastic body is interposed between the nut and the sleeve. In this case, the power transmission between the nut and the sleeve may be effected using a shearing force of the elastic body, or may be effected using a compressive force.

Preferably, a convex portion is formed on an outer peripheral surface of the nut, and a concave portion is formed in an inner peripheral surface of the sleeve, and the nut is engaged in the sleeve, with the convex portion engaged in the concave portion.

In case at least part of the convex portion is disposed radially outwardly of the circulating passage of the body, the shape of the nut can be made optimum.

In case a buffer member is disposed between the convex portion and the concave portion in a peripheral direction, an impact force, even when transmitted from the electric motor or the rack shaft, can be relieved.

In case each of the nut and the sleeve has axially-extending projections, and further a first buffer body is disposed between the projections of the nut and the projections of the sleeve, the first buffer body can suppress vibrations and noises at the time of transmitting a torque, and also can eliminate a jarring motion between the nut and the sleeve in the axial direction, and furthermore a misalignment-suppressing effect can be expected.

In case one of the nut and the sleeve has axially-extending projections, and the other has recesses engaged respectively with the projections, power can be transmitted between the nut and the sleeve.

In case a first buffer body is disposed between the projections and the recesses, the first buffer body can suppress vibrations and noises at the time of transmitting a torque, and also can eliminate a jarring motion between the nut and the sleeve in the axial direction, and furthermore a misalignment-suppressing effect can be expected.

In case a gap which is reduced by a relative movement of the nut and the sleeve in a direction to compress the first buffer body is formed between the nut and the sleeve, the effect of the first buffer body can be effectively achieved, and therefore this is preferable.

In case there is provided a threaded member threaded in the inner periphery of the sleeve, and a second buffer body is disposed between the threaded member and the nut, the second buffer body can suppress vibrations and noises at the time of transmitting a torque, and also can eliminate a jarring motion between the nut and the sleeve in the axial direction, and furthermore a misalignment-suppressing effect can be expected.

In case a gap which is reduced by a relative movement of the nut and the threaded member in a direction to compress the second buffer body is formed between the nut and the threaded member, the effect of the second buffer body can be effectively achieved, and therefore this is preferable.

In case the nut and the sleeve are connected together by a key, and can rotate in unison, the torque transmission can be positively effected with the simple construction, and therefore this is preferable.

Preferably, the reception portion is a gear portion formed on an outer peripheral surface of the sleeve, and power from the electric motor is transmitted via another gear in mesh with the gear portion; however, the power may be transmitted via a toothed belt or a chain engaged with the gear portion.

In the electric power steering apparatus of the present invention, the nut has the deflectors which are provided respectively at the opposite ends of the body, and pick up the rolling members, rolling in the rolling passage, in the tangential direction of the rolling passage and also in the direction of the lead angle thereof to return the rolling members to the circulating passage, and therefore it is not necessary to provide a conventional piece, a conventional tube or the like at the outer peripheral surface of the nut, and therefore the outer diameter of the nut can be kept to a small size. And besides, as compared with an end cap-type, the axial length of the nut can be kept to a short size.

Furthermore, the deflectors are the members separate from the nut, and therefore need to be mounted on the nut. Therefore, in case power of the electric motor is transmitted to the nut via the fixing member fixing the deflector to the nut, the power transmission can be effected without increasing the outer diameter of the nut. As a result, the reduction of the number of the parts, a space-saving design, etc., can be achieved. And besides, power will not be transmitted to the deflector, and therefore deformation and breakage due to the power transmission will not occur.

Preferably, the deflector is pressed against the nut by an end surface of the fixing member.

Preferably, the nut and the fixing member are positioned by a spigot joint.

In case at least part of the circulating passage is formed by applying a groove-forming processing to the body in a radial direction, the processing of the nut body can be effected easily.

In case a bearing is disposed radially outwardly of the formed groove, the groove can be used as the circulating passage.

In case a lid member covering at least part of the circulating passage is disposed between the groove and the bearing, the rolling of the balls passing through the circulating passage becomes smooth, and therefore this is preferable.

In the electric power steering apparatus of the present invention, the nut has the deflectors which are provided respectively at the opposite ends of the body, and pick up the rolling members, rolling in the rolling passage, in the tangential direction of the rolling passage and also in the direction of the lead angle thereof to return the rolling members to the circulating passage, and therefore it is not necessary to provide a conventional piece, a conventional tube or the like at the outer peripheral surface of the nut, and therefore the outer diameter of the nut can be kept to a small size. And besides, as compared with an end cap-type, the axial length of the nut can be kept to a short size.

On the one hand, a conventional deflector is directly screw-fastened to the nut, or is fixed to the nut, using a separate fixing-purpose plate, and therefore there is a problem that the number of the parts increases, and besides much time and labor are required for the assembling. On the other hand, in the present invention, the deflector is mounted on the nut by the fastening means fixing the bearing supporting the nut, and therefore the number of the parts necessary for the assembling is reduced, and also the assembling becomes easy.

In case an elastic body is interposed between the deflector and the fastening means, vibration and noises of the deflector during the operation can be reduced by the elastic body.

In case a projection is formed on the deflector, and the deflector is fixed by holding the fastening means against the projection, the deflector can be easily fixed.

In the electric power steering apparatus of the present invention, the nut has the deflectors which are provided respectively at the opposite ends of the body, and pick up the rolling members, rolling in the rolling passage, in the tangential direction of the rolling passage and also in the direction of the lead angle thereof to return the rolling members to the circulating passage, and therefore it is not necessary to provide a conventional piece, a conventional tube or the like at the outer peripheral surface of the nut, and therefore the outer diameter of the nut can be kept to a small size. And besides, as compared with an end cap-type, the axial length of the nut can be kept to a short size.

Furthermore, the deflector need only to have the function of picking up the balls from the rolling passage to the circulating passage, and therefore when the deflector is mounted on the nut, part of the end surface of the body can be exposed. Therefore, the axially-extending projections or the axially-indented recesses are provided at the exposed end surface, and these are superposed on projections or recesses of an external member in the peripheral direction, and a pressing force is transmitted from one to the other so as to transmit power of the electric motor to the nut, and by doing so, the power of the electric motor can be transmitted to the nut without increasing the outer diameter of the nut. And besides, power will not be transmitted to the deflector, and therefore deformation or breakage due to the power transmission will not occur.

In case an elastic body is provided between a driven member for receiving power from the electric motor and the projections or the recesses, vibrations and noises during the operation can be reduced.

### BRIEF DESCRIPTION OF THE DRAWINGS

FIG. 1 is a cross-sectional view of an important portion of an electric power steering apparatus 11 of a first embodiment.

FIG. 2 is a view in which a nut of FIG. 1 is cut along the line II-II, and is seen in a direction of arrows.

FIG. 3 is a cross-sectional view of an important portion of an electric power steering apparatus 111 of a second embodiment.

FIG. 4 is a view showing that portion of the construction of FIG. 1 indicated by arrow IV on an enlarged scale.

FIG. 5 is a view in which the construction of FIG. 4 is cut along the line V-V, and is seen in a direction of arrows.

FIG. 6 is a cross-sectional view of an important portion of an electric power steering apparatus 211 of a third embodiment.

FIG. 7 is an exploded view of a nut and a driven gear.

FIG. 8 is a view of the nut as seen in an axial direction, with deflectors removed therefrom.

FIG. 9 is a schematic cross-sectional view of an end cap-type ball screw mechanism.

FIG. 10 is a cross-sectional view of an important portion of an electric power steering apparatus 311 of a fourth embodiment.

FIG. 11 is a cross-sectional view of an important portion of an electric power steering apparatus of a fifth embodiment.

FIG. 12A is an axial cross-sectional view of a ball screw mechanism of a sixth embodiment.

FIG. 12B is a view in which a nut of FIG. 12A is cut along the line XIIB-XIIB, and is seen in a direction of arrows.

FIG. 13A is an axial cross-sectional view of a ball screw mechanism of a seventh embodiment.

FIG. 13B is a view in which a nut of FIG. 13A is cut along the line XIIIB-XIIIB, and is seen in a direction of arrows

FIG. 14A and FIG. 14B are cross-sectional views of modified examples of the ball screw mechanism in a direction perpendicular to an axis thereof.

FIG. 15A and FIG. 15B are cross-sectional views of modified examples of the ball screw mechanism in a direction perpendicular to an axis thereof.

FIG. 16 is a cross-sectional view of a ball screw mechanism of an eighth embodiment in a direction perpendicular to an axis thereof.

FIG. 17 is a cross-sectional view of a ball screw mechanism of a ninth embodiment in a direction perpendicular to an axis thereof.

FIG. 18 is a cross-sectional view of a modified example of the ball screw mechanism in a direction perpendicular to an axis thereof.

FIG. 19 is a cross-sectional view of a modified example of the ball screw mechanism in a direction perpendicular to an axis thereof.

FIG. 20 is a cross-sectional view of an important portion of an electric power steering apparatus 1511 of a tenth embodiment.

FIG. 21 is a cross-sectional view of an important portion of an electric power steering apparatus 1611 of an eleventh embodiment.

FIG. 22 is an exploded perspective view of a nut and a sleeve of the eleventh embodiment.

FIG. 23(a) is a view showing an end surface of the nut of this embodiment, FIG. 23(b) is a view in which the construction of FIG. 23(a) is cut along the line XXIIIB-XXIIIB, and is seen in a direction of arrows, and FIG. 23(c) is a view showing a deflector.

FIG. 24 is a cross-sectional view of an important portion of an electric power steering apparatus 1711 of a twelfth embodiment.

FIG. 25 is a cross-sectional view of an important portion of an electric power steering apparatus 1811 of a thirteenth embodiment.

FIG. 26 is an exploded perspective view showing a nut and an inner ring holder of the thirteenth embodiment.

FIG. 27 is a cross-sectional view of an important portion of an electric power steering apparatus 1911 of a fourteenth embodiment.

FIG. 28 is a cross-sectional view of an important portion of an electric power steering apparatus 2011 of a fifteenth embodiment.

FIG. 29 is a view in which the construction of FIG. 28 is cut along the line XXIX-XXIX, and is seen in a direction of arrows

FIG. 30 is a cross-sectional view of an important portion of an electric power steering apparatus 2111 of a sixteenth embodiment.

FIG. 31 is a cross-sectional view of an important portion of an electric power steering apparatus 3011 of a seventeenth embodiment.

FIG. 32 is a cross-sectional view of a nut and a fixing member in an assembled condition.

FIG. 33 is a view in which the nut of FIG. 32 is seen in a direction of arrows XXXIII.

FIG. 34 is a cross-sectional view of an important portion of an electric power steering apparatus 3111 of an eighteenth embodiment.

FIG. 35 is a top plan view of a body of a nut of a further embodiment which can be used in the electric power steering apparatuses shown in FIGS. 31 and 34.

FIG. 36 is a view in which the nut body shown in FIG. 35 is seen in a direction of arrow XXXVI.

FIG. 37 is a view in which the nut body shown in FIG. 36 is cut along the line XXXVII-XXXVII, and is seen in a direction of arrows.

FIG. 38 is a view in which the nut body shown in FIG. 37 is cut along the line XXXVIII-XXXVIII, and is seen in a direction of arrows.

FIG. 39 is a view showing a condition in which a bearing is mounted on the nut body.

FIG. 40 is a view in which the construction of FIG. 39 is cut along the line XXXX-XXXX, and is seen in a direction of arrows.

FIG. 41 is a top plan view of a body of a nut of a modified example.

FIG. 42 is a view in which the nut body shown in FIG. 41 is seen in a direction of arrow XXXXII.

FIG. 43 is a view in which the nut body shown in FIG. 42 is cut along the line XXXXIII-XXXXIII, and is seen in a direction of arrows.

FIG. 44 is a view in which the nut body shown in FIG. 43 is cut along the line XXXXIV-XXXXIV, and is seen in a direction of arrows.

FIG. 45 is a view showing a condition in which a bearing is mounted on the nut body of this modified example, and is a cross-sectional view similar to FIG. 40.

FIG. 46 is a cross-sectional view showing an electric power steering apparatus 3211 employing the modified example shown in FIGS. 41 to 45.

FIG. 47 is a cross-sectional view of an electric power steering apparatus 3311 of a nineteenth embodiment.

FIG. 48 is a cross-sectional view of an important portion of an electric power steering apparatus 4011 of a twentieth embodiment.

FIG. 49 is a cross-sectional view showing a nut of the electric power steering apparatus of the twentieth embodiment in an assembled condition.

FIG. 50 is a cross-sectional view showing a nut of an electric power steering apparatus of a twenty-first embodiment in an assembled condition.

FIG. 51 is a cross-sectional view of an important portion of an electric power steering apparatus 5011 of a twenty-second embodiment.

FIG. 52 is a cross-sectional view showing a nut alone.

FIG. 53 is a view in which the nut of FIG. 52 is seen in a direction of arrow XXXXXIII.

FIG. 54 is an exploded perspective view of the nut and a driven gear.

### BEST MODE FOR CARRYING OUT THE INVENTION

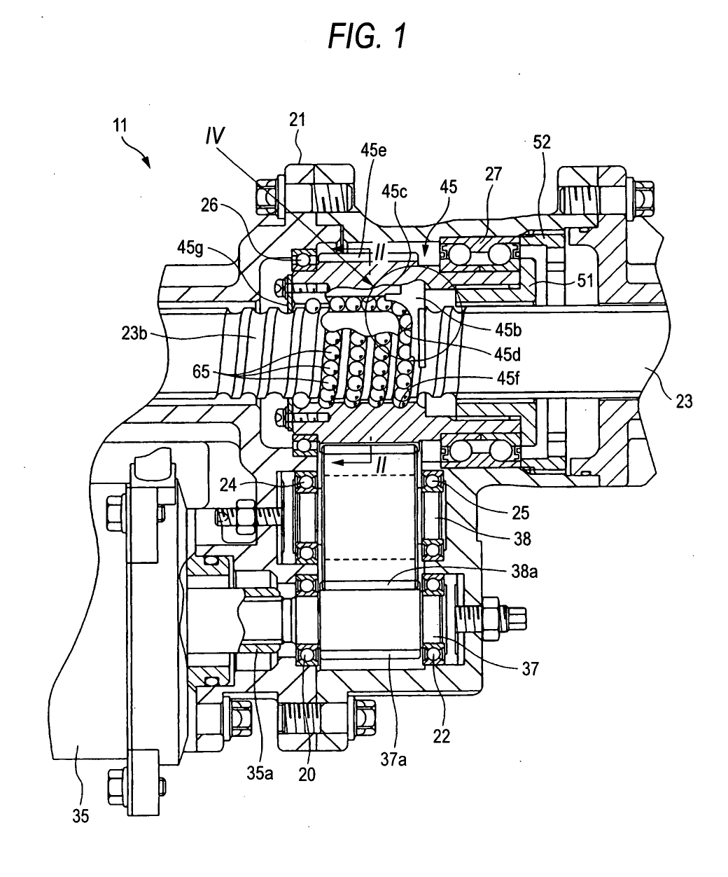

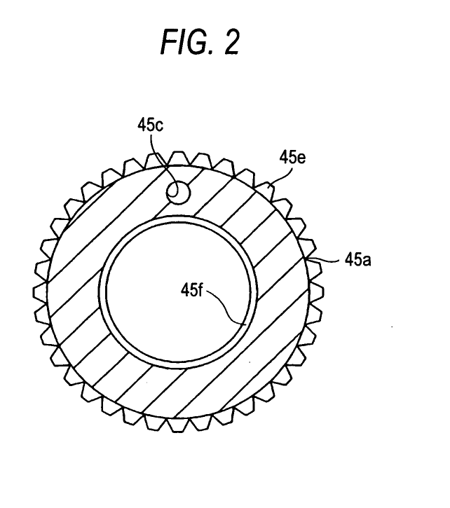

An embodiment of the present invention will now be described with reference to the drawings. FIG. 1 is a cross-sectional view of an important portion of an electric power steering apparatus of the first embodiment. FIG. 2 is a view in which a nut of FIG. 1 is cut along the line II-II, and is seen in a direction of arrows, but a screw shaft and balls are omitted. In FIG. 1, the electric power steering apparatus 11 includes a housing 21 fixed to a vehicle body which is not shown. A rack shaft 23 extends horizontally through the housing 21, and is supported so as to be moved in an axial direction. Although not shown, a pinion is formed at a lower end of an input shaft connected to a steering wheel, and is in mesh with rack teeth of the rack shaft 23, and the rack shaft 23 is moved left and right in the drawings by rotation of the input shaft. Opposite ends of the rack shaft 23 are connected to a tie rod (not shown) of a steering mechanism.

An electric motor 35 is mounted on the housing 21 in such a manner that its axis is parallel to the rack shaft 23. An output shaft 35a of the electric motor 35 is fixed by serration connection to a drive shaft 37 so that it can make a relative displacement in the axial direction, and can move in unison with the drive shaft in a rotational direction. The drive shaft 37 is rotatably supported on the housing 21 by bearings 20, 22, and has a drive gear portion 37a at a portion thereof interposed between the bearings 20, 22.

An intermediate shaft 38 is disposed between the drive shaft 37 and the rack shaft 23. The intermediate shaft 38 is rotatably supported on the housing 21 by bearings 24, 25, and has an intermediate gear portion 38a which is interposed at a portion thereof interposed between the bearings 24, 25, and is in mesh with the drive gear portion 37a.

The nut 45 is disposed on the periphery of the rack shaft 23, and is rotatably supported on the housing 21 by a ball bearing 26 and a double row angular contact ball bearing 27. An inner ring of the double row angular contact ball bearing 27 is fixed by an inner ring holder 51 threadedly engaged with the inner periphery of the nut 45 in such a manner that the inner ring holder applies a preload to the inner ring, and an outer ring of the double row angular contact ball bearing 27 is fixed by an outer ring holder 52 threadedly engaged with the inner periphery of the housing 21. Therefore, the nut 45 is mounted in such a condition that a jarring motion of the nut in the axial direction is suppressed.

The nut 45 includes a central body 45a of a hollow cylindrical shape, and deflectors 45b (only the one-side one is shown) provided respectively at opposite ends thereof. As shown in FIG. 2, the body 45a forms a circulating passage 45c extending therethrough in an axial direction.

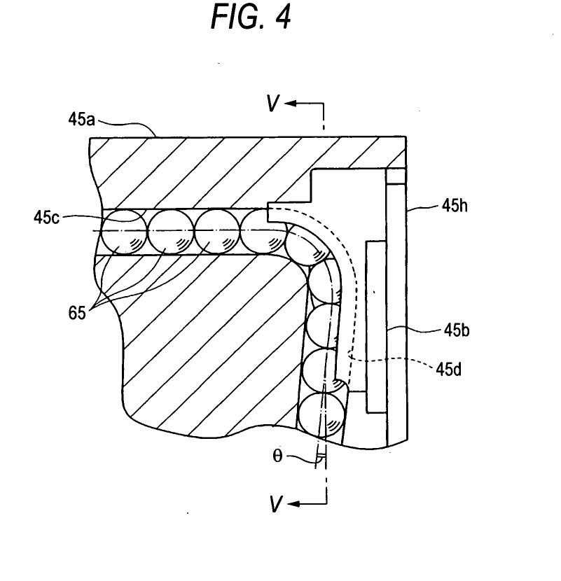

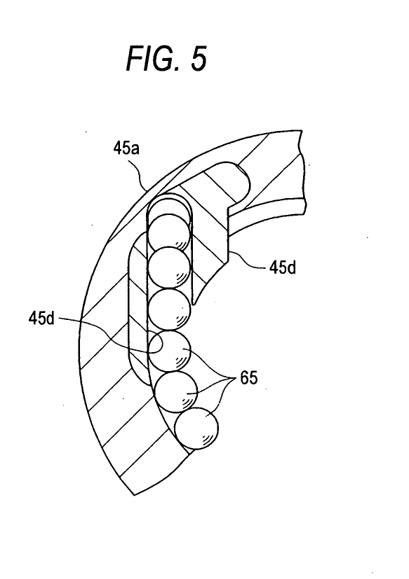

FIG. 4 is a view showing that portion of the construction of FIG. 1 indicated by arrow IV on an enlarged scale, and FIG. 5 is a view in which the construction of FIG. 4 is cut along the line V-V, and is seen in a direction of arrows. Each of the deflectors 45b (only one is shown in FIGS. 4 and 5), mounted by a fixing plate 45h screw-fastened to the body 45a, forms a pick-up piece 45d which picks up rolling balls 65 in a direction of a lead angle (θ) of the screw shaft as shown in FIG. 4, and also picks up the balls in a tangential direction of a rolling passage (screw grooves) as shown in FIG. 5, so as to return the balls to the circulating passage 45c.

In FIG. 1, a fixing plate 45g is screw-fastened to a left end (in the drawings) of the body 45a. Further, a driven gear portion (reception portion) 45e in mesh with the intermediate gear portion 38a is provided at that portion of the body 45a interposed between the bearings 26, 27. The drive gear 37a, the intermediate gear portion 38a and the driven gear portion 45e form gear pairs.

A male screw groove 23b is formed in part of the outer peripheral surface of the rack shaft 23 integral with the screw shaft (A separate part may be connected). The nut 45 is disposed around the periphery of the male screw groove 23b, and a female screw groove 45f is formed in an inner peripheral surface of the body 45a opposed to the male screw groove 23b. A number of balls 65 are rollably disposed within a spiral space (rolling passage) formed by the male screw groove 23b and the female screw groove 45f. The screw shaft 23, the nut 45 and the balls 65 form a ball screw mechanism (power transmission mechanism).

The operation of this embodiment will be explained. Although not shown, when the driver rotates the steering wheel, its rotational force is transmitted to the input shaft. When the input shaft rotates, the rack teeth pinion-meshed therewith are pushed, and the rack shaft 23 is moved in the axial direction to drive the steering mechanism (not shown) via the tie rod, thereby effecting the steering of vehicle wheels.

At this time, a torque sensor not shown detects a steering torque, and in accordance with its amount, a CPU not shown supplies electric power to the electric motor 35, and therefore the drive gear portions 37a rotates together with the output shaft, and the gear portion 45e meshed therewith through the intermediate gear portion 38a is rotated at a predetermined reduction ratio. As a result, the nut 45 also rotates, and this rotational motion is converted into an axial movement of the rack shaft 23 via the balls 65. The ball 65, rolled to one end of the rolling passage, is picked up by the deflector 45b, and is returned to the other end through the circulating passage 45c. An assist steering force can be outputted, using the axial force of the rack shaft 23.

In the electric power steering apparatus 11 of this embodiment, the nut 45 picks up the balls 65 from the rolling passage (23b, 45f) in the tangential direction and the lead angle-direction of the rolling passage, and therefore the balls 65 can be picked up to the circulating passage 45c without changing the direction of rolling of the balls 65, and therefore the smooth rolling can be secured, and operating sounds and vibrations can be kept to a low level. And besides, the deflectors 45b are provided respectively at the opposite ends of the body 45a, and therefore it is not necessary to provide a piece or a tube at the outer peripheral surface of the body 45a, and the reception portion for receiving power transmitted from the electric motor 35, that is, the driven gear portion 45e, can be provided at the central portion of the outer peripheral surface disposed radially outwardly of the rolling passage, and therefore when power is transmitted from the electric motor 35 to the driven gear portion 45e, the wrenching of the nut 45 is suppressed, thereby enabling the smooth operation. Furthermore, by providing the driven gear portion 45e (which receives power transmitted from the electric motor 35) at the outer peripheral surface disposed radially outwardly of the rolling passage, the increase of the axial length of the nut 45 can also be suppressed.

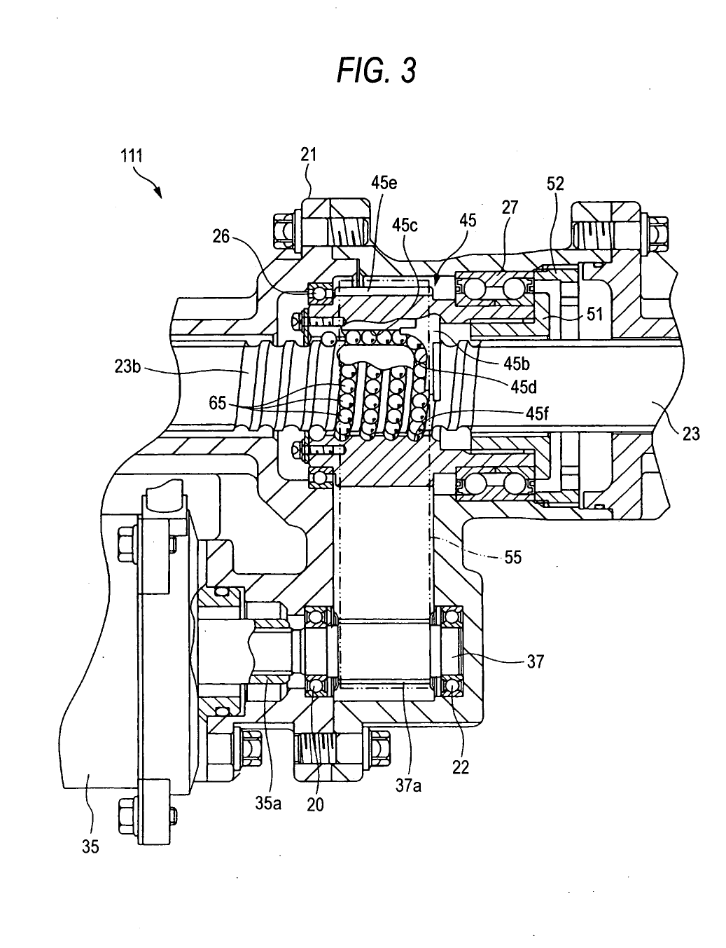

FIG. 3 is a cross-sectional view of an important portion of an electric power steering apparatus 111 of a second embodiment. In this embodiment, only those points different from the embodiment shown in FIGS. 1 and 2 will be described, and with respect to common constructions, identical reference numerals will be applied, and explanation thereof will be omitted.

In this embodiment, instead of omitting the intermediate shaft, there is provided a toothed belt 55 engaged with a gear portion 37a of a drive gear 37 and a driven gear portion 45e of a body 45. Therefore, when the drive gear portion 37a rotates together with an output shaft 35a of an electric motor 35, the driven gear portion 45e is rotated at a predetermined reduction ratio via the toothed belt 55. As a result, a nut 45 also rotates, and therefore power of the electric motor 35 can be transmitted to a screw shaft 23. Incidentally, a chain may be used instead of the toothed belt.

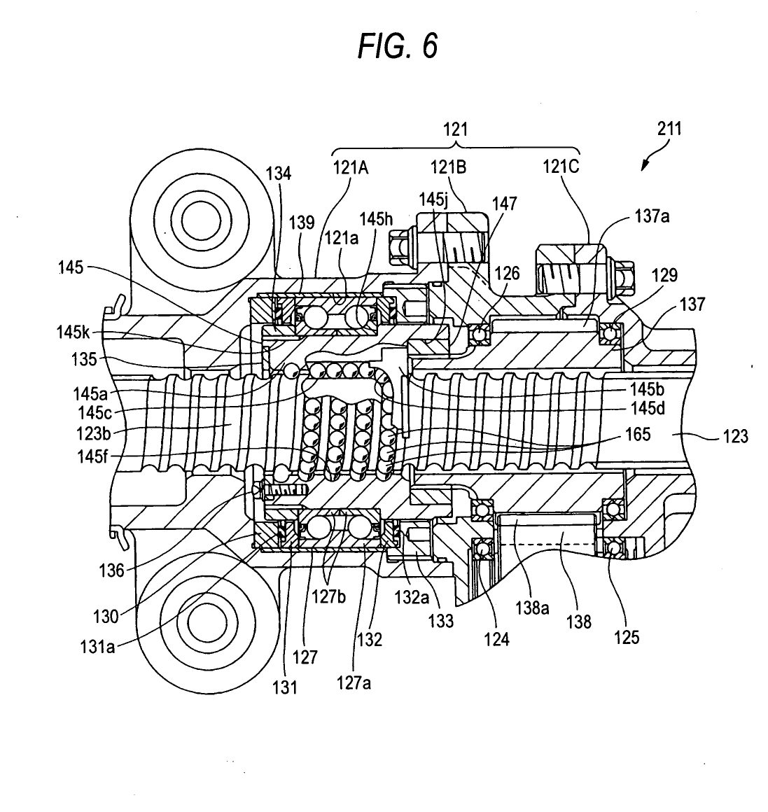

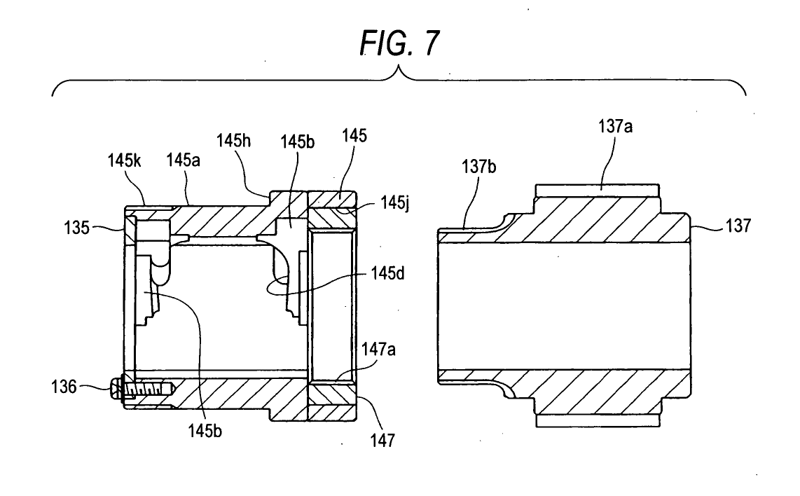

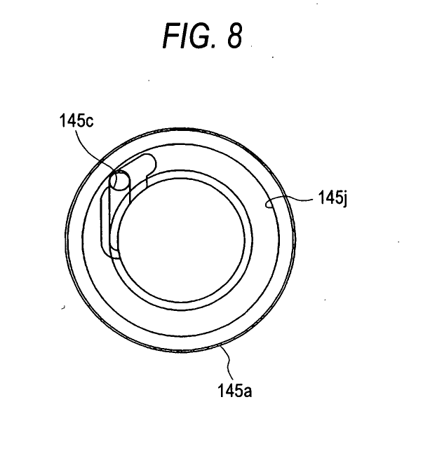

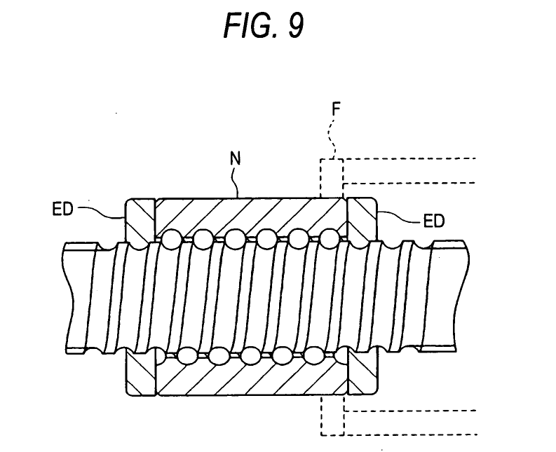

FIG. 6 is a cross-sectional view of an important portion of an electric power steering apparatus 211 of a third embodiment. FIG. 7 is an exploded view of a nut and a driven gear, and FIG. 8 is a view of the nut as seen in an axial direction, with deflectors removed therefrom.

In FIG. 6, the electric power steering apparatus 211 has a housing 121 fixed to a vehicle body not shown. The housing 121 is divided into three sections in FIG. 6, and comprises members 121A, 121B, 121C fastened together into a unitary form by bolts. A rack shaft 123 extends horizontally through the housing 121, and is supported so as to be moved in an axial direction. Although not shown, a pinion is formed at a lower end of an input shaft connected to a steering wheel, and is in mesh with rack teeth of the rack shaft 123, and the rack shaft 123 is moved left and right in the drawings by rotation of the input shaft. Opposite ends of the rack shaft 123 are connected to a tie rod (not shown) of a steering mechanism.

An electric motor (not shown) is mounted on the housing 121 in such a manner that its axis is parallel to the rack shaft 123. Power of the electric motor is transmitted to an intermediate shaft 138 only part of which is shown in FIG. 6. The intermediate shaft 138 is rotatably supported on the housing 121 by bearings 124, 125, and has an intermediate gear portion 138a at a portion thereof interposed between the bearings 124, 125.

The nut 145 is disposed around the periphery of the rack shaft 123, and is rotatably supported on the housing 121 by a double row angular contact ball bearing 127. This will now be described more specifically. A thin-wall cylindrical sleeve 139 is fittingly disposed within an inner hole 121a of the member 121A of the housing 121. And, a ring-like member 130, a first buffer member 131, an outer ring 127a of the double row angular contact ball bearing 127 and a second buffer member 132 are arranged in this order from a bottom surface (the left side in FIG. 6) of the inner hole 121a, and are fixed by a lock member 133 threadedly engaged with the member 121A. The first buffer member 131 has an elastic body 131a abutting against the ring-like member 130. And, the second buffer member 132 has an elastic body 132a abutting against the lock member 133. By elastic deformation of the elastic bodies 131a, 132a, the double row angular contact ball bearing 127 can move together with the nut 145 in the axial direction within a limited range. The outer ring 127a is fitted in an inner peripheral surface of the sleeve 139.

An inner ring 127b, 127b of the double row angular contact ball bearing 127, which is divided in two sections juxtaposed in the axial direction, is fitted on an outer peripheral surface of the nut 145, and its right end (in the drawings) abuts against an outer peripheral step portion 145h formed at that portion of the nut 145 near to a right end thereof. And, the left end (in the drawings) of the inner ring 127b, 127b abuts against a right end of a threaded member 134, so that a preload is applied to the inner ring. The threaded member 134 is threaded on a threaded portion 145K formed on the outer peripheral surface of the nut 145. The preload can be adjusted by the amount of threading of the threaded member 134.

In FIG. 7, the nut 145 includes a body 145a of a hollow cylindrical shape, and the deflectors 145b provided respectively at opposite ends thereof. The body 145a forms a circulating passage 145c (see FIG. 6) extending therethrough in an axial direction. Each deflector 145b forms a pick-up piece 145d which picks up rolling balls 165 in a tangential direction of a rolling passage and also in a direction of a lead angle thereof to return the balls to the circulating passage 145c. The deflector 145b has a shape similar to that of the deflector 45b shown in FIGS. 4 and 5.

In FIG. 7, the deflector 145b is disposed at a left end of the body 145a of the nut 145, and is fixed by a doughnut disk-shaped holding plate 135 screw-fastened to the body 145a by a screw 136. On the one hand, the deflector 145b is disposed at a right end of the body 145a of the nut 145, and is fixed by an annular fixing member 147 press-fitted in a larger-diameter portion 145j formed at the inner periphery of the right end of the nut 145. A female serration portion 147a is formed on the inner periphery of the annular member 147.

In FIG. 6, the hollow driven gear 137 which is a driven member (external member) is rotatably supported at its opposite ends on the housing 121 by bearings 126, 129, and has a driven gear portion 137a in mesh with the intermediate gear portion 138a, and also has a male serration portion 137b formed on the outer periphery of a left end thereof. The intermediate gear portion 138a and the driven gear portion 137a form a gear pair. Incidentally, the nut 145, etc., can be mounted from the right side in the drawings in a condition in which the members 121A, 121B of the housing 121 are removed.

By engaging the male serration portion 137b of the driven gear 137 with the female serration portion 147a of the annular member 147, the driven gear 137 and the fixing member 147 are interconnected in such a manner that the two can move relative to each other in an axial direction, but can not rotate relative to each other in a rotational direction. The driven gear 137 and the fixing member 147 are arranged so as to move relative to each other in the axial direction in order that the buffering effect of the elastic bodies 131a, 132a can be achieved. Even when a large load is transmitted to between the male serration portion 137b of the driven gear 137 and the female serration portion 147a of the annular member 147, stresses will not directly act on the deflectors 145b, and therefore deformation thereof is suppressed, and the improper rolling of the balls 165 will not be incurred.

Thus, in this embodiment, by press-fitting the annular member 147, having the female serration portion 147a formed thereon, into the nut 145 without forming a female serration portion on the nut 145, there is achieved an advantage that the production of the nut 145 becomes easy, and also there are other points such as an advantage that the outer diameter of the nut 145 becomes irrelevant to the inner diameter of the female serration portion 147a, so that the annular member can be arbitrarily exchanged with an annular member having an outer diameter, a teeth number, etc., of a serration which are changed according to the specifications.

In FIG. 6, a male screw groove 123b is formed in part of the outer peripheral surface of the rack shaft 123 integral with the screw shaft (A separate part may be connected). The nut 145 is disposed around the periphery of the male screw groove 123b, and a female screw groove 145f is formed in the inner peripheral surface of the body 145a opposed to the male screw groove 123b. A number of balls (rolling members) 165 are rollably disposed within a spiral space (rolling passage) formed by the male screw groove 123b and the female screw groove 145f. The screw shaft 123, the nut 145 and the balls 165 form a ball screw mechanism (power transmission mechanism).

The operation of this embodiment will be explained. Although not shown, when the driver rotates the steering wheel, its rotational force is transmitted to the input shaft. When the input shaft rotates, the rack teeth pinion-meshed therewith are pushed, and the rack shaft 123 is moved in the axial direction to drive the steering mechanism (not shown) via the tie rod, thereby effecting the steering of vehicle wheels.

At this time, a torque sensor not shown detects a steering torque, and in accordance with its amount, a CPU not shown supplies electric power to the electric motor, and therefore the driven gear portion 137a meshed via the intermediate gear portion 138a is rotated at a predetermined reduction ratio. Therefore, the rotational power is transmitted from the driven gear 137 to the nut 145 via the fixing member 147, and a rotational motion of the nut 145 is converted into an axial movement of the rack shaft 123 via the balls 165. The ball 165, rolled to one end of the rolling passage, is picked up by the deflector 145b, and is returned to the other end through the circulating passage 145c. An assist steering force can be outputted, using the axial force of the rack shaft 123.

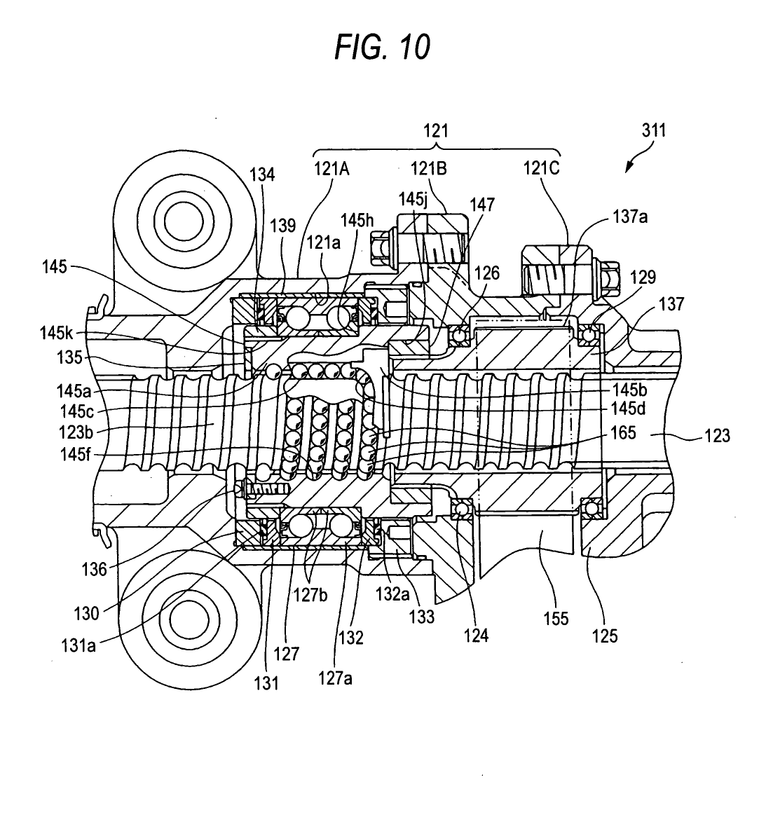

FIG. 10 is a cross-sectional view of an important portion of an electric power steering apparatus 311 of a fourth embodiment. In this embodiment, only those points different from the embodiment shown in FIG. 6 will be described, and with respect to common constructions, identical reference numerals will be applied, and explanation thereof will be omitted.

In this embodiment, instead of omitting the intermediate shaft, there is provided a toothed belt 155 for transmitting power to a gear portion 137a of a driven shaft 137. Therefore, power from an electric motor not shown is transmitted to the driven shaft 137 via the toothed belt 155, and a nut 145 connected thereto also rotates, and therefore power of the electric motor can be transmitted to a screw shaft 123. Incidentally, a chain may be used instead of the toothed belt.

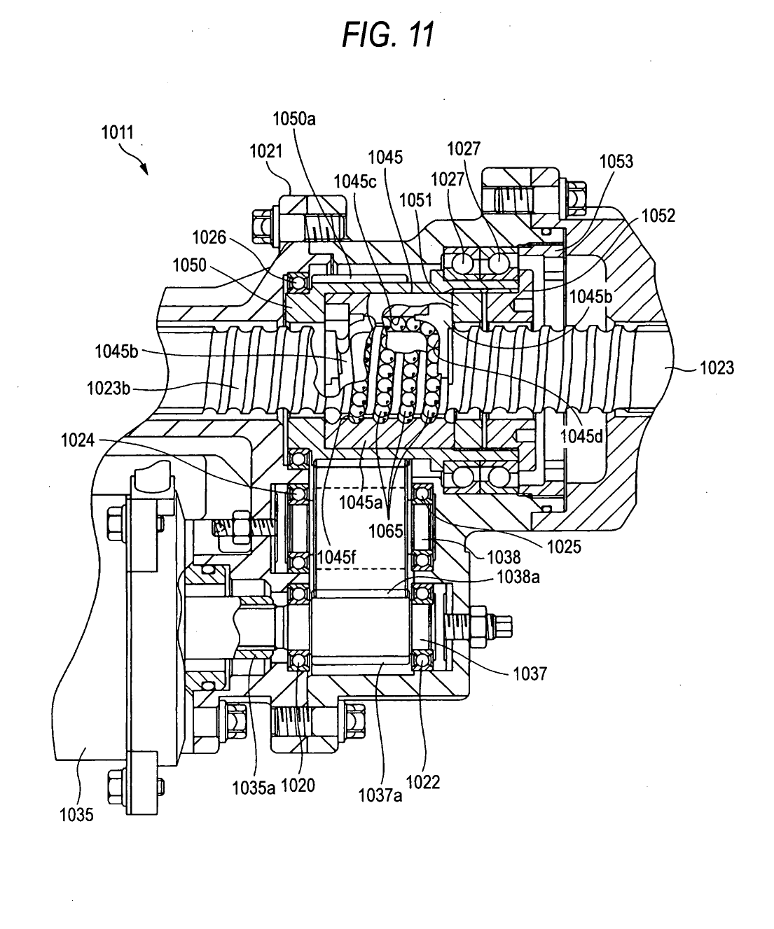

FIG. 11 is a cross-sectional view of an important portion of an electric power steering apparatus of a fifth embodiment. In FIG. 11, the electric power steering apparatus 1011 has a housing 1021 fixed to a vehicle body not shown. A rack shaft 1023 extends horizontally through the housing 1021, and is supported so as to be moved in an axial direction. Although not shown, a pinion is formed at a lower end of an input shaft connected to a steering wheel, and is in mesh with rack teeth of the rack shaft 1023, and the rack shaft 1023 is moved left and right in the drawings by rotation of the input shaft. Opposite ends of the rack shaft 1023 are connected to a tie rod (not shown) of a steering mechanism.

An electric motor 1035 is mounted on the housing 1021 in such a manner that its axis is parallel to the rack shaft 1023. An output shaft 1035a of the electric motor 1035 is fixed by serration connection to a drive shaft 1037 so that it can make a relative displacement in the axial direction, and can move in unison with the drive shaft in a rotational direction. The drive shaft 1037 is rotatably supported on the housing 1021 by bearings 1020, 1022, and has a drive gear portion 1037a at a portion thereof interposed between the bearings 1020, 1022.

An intermediate shaft 1038 is disposed between the drive shaft 1037 and the rack shaft 1023. The intermediate shaft 1038 is rotatably supported on the housing 1021 by bearings 1024, 1025, and has an intermediate gear portion 1038a which is interposed at a portion thereof interposed between the bearings 1024, 1025, and is in mesh with the drive gear portion 1037a.

A cylindrical sleeve 1050 is disposed around the periphery of the rack shaft 1023, and is rotatably supported on the housing 1021 by a ball bearing 26 and angular contact ball bearings 1027, 1027. A nut 1045 through which the rack shaft 1023 extends is fitted in the sleeve 1050, and is fixed by a threaded member 1051 threaded in the inner periphery of the sleeve. Therefore, the sleeve 1050 and the nut 1045 rotate in unison.

Inner rings of the angular contact ball bearings 1027, 1027 are fixed by an inner ring holder 1052 threadedly engaged with the inner periphery of the sleeve 1050 in such a manner that the inner ring holder applies a preload to the inner rings, and outer rings of the angular contact ball bearing 1027, 1027 are fixed by an outer ring holder 1053 threadedly engaged with the inner periphery of the housing 1021. Therefore, the sleeve 1050 is mounted in such a condition that a jarring motion of the sleeve in the axial direction is suppressed.

The nut 1045 includes a central body 1045a of a hollow cylindrical shape, and deflectors 1045b, 1045b provided respectively at opposite ends thereof. The body 1045a forms a circulating passage 1045c extending therethrough in an axial direction. Each deflector 1045b forms a pick-up piece 1045d which picks up rolling balls 1065 in a tangential direction of a rolling passage and also in a direction of a lead angle thereof to return the balls to the circulating passage 1045c. Further, the sleeve 1050 has a driven gear portion (reception portion) 1050a which is formed at a portion thereof interposed between the bearings 1026 and 1027, and is in mesh with the intermediate gear portion 1038a. The drive gear portion 1037a, the intermediate gear portion 1038a and the driven gear portion 1050a form gear pairs.

A male screw groove 1023b is formed in part of the outer peripheral surface of the rack shaft 1023 integral with the screw shaft (A separate part may be connected). The nut 1045 is disposed around the periphery of the male screw groove 1023b, and a female screw groove 1045f is formed in the inner peripheral surface of the body 1045a opposed to the male screw groove 1023b. A number of balls 1065 are rollably disposed within a spiral space (rolling passage) formed by the male screw groove 1023b and the female screw groove 1045f.

The operation of this embodiment will be explained. Although not shown, when the driver rotates the steering wheel, its rotational force is transmitted to the input shaft. When the input shaft rotates, the rack teeth pinion-meshed therewith are pushed, and the rack shaft 23 is moved in the axial direction to drive the steering mechanism (not shown) via the tie rod, thereby effecting the steering of vehicle wheels.

At this time, a torque sensor not shown detects a steering torque, and in accordance with its amount, a CPU not shown supplies electric power to the electric motor 1035, and therefore the drive gear portion 1037a rotates together with the output shaft, and the driven gear portion 1050a meshed therewith via the intermediate gear portion 1038a is rotated at a predetermined reduction ratio. As a result, the nut 1045 also rotates together with the sleeve 1050, and its rotational motion is converted into an axial movement of the rack shaft 1023 via the balls 1065. The ball 1065, rolled to one end of the rolling passage, is picked up by the deflector 1045b, and is returned to the other end through the circulating passage 1045c. An assist steering force can be outputted, using the axial force of the rack shaft 1023.

In the electric power steering apparatus 1011 of this embodiment, the nut 1045 is inserted in and fixed to the sleeve 1050 so as to rotate in unison therewith, and therefore regardless of the shape of the outer peripheral surface of the nut 1045, the driven gear portion 1050a for receiving power transmitted from the electric motor 1035 can be provided at the outer peripheral surface or other portion of the sleeve 1050 disposed radially outwardly of the rolling passage (1023b, 1045f), and therefore when power is transmitted from the electric motor 1035 to the driven gear portion 1050a, the wrenching of the nut 1045 is suppressed, thereby enabling the smooth operation. And besides, by providing the driven gear portion 1050a (which receives power transmitted from the electric motor 1035) at the outer peripheral surface or other portion disposed radially outwardly of the rolling passage (1023b, 1045f), the increase of the axial length of the sleeve 1050 as well as the increase of the axial length of the nut 1045 can be suppressed. Furthermore, since the nut 1045 having the female screw groove 1045f formed therein is inserted in and fixed to the sleeve 1050 having the driven gear portion 1050a formed thereon, the two can be processed separately from each other, and therefore the production cost can be reduced.

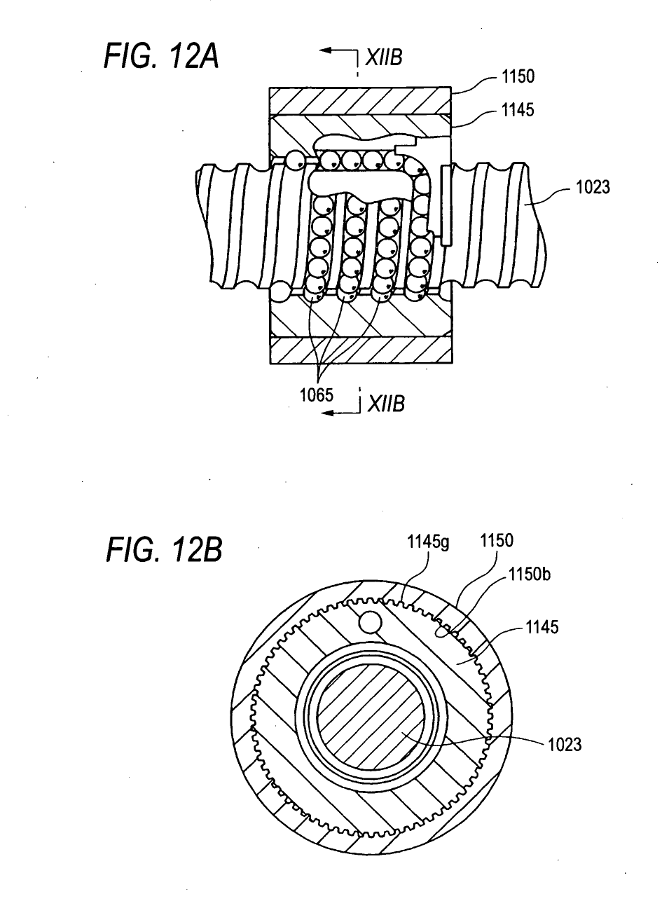

FIG. 12A is an axial cross-sectional view of a ball screw mechanism of a sixth embodiment, and FIG. 12B is a view in which a nut of FIG. 12A is cut along the line XIIB-XIIB, and is seen in a direction of arrows, but balls are omitted. In FIG. 12, a sleeve 1150 and the nut 1145 are serration-connected together. More specifically, the nut 1145 is inserted in and fixed to the sleeve 1150 in such a manner that female serrations 1150b formed at the inner periphery of the sleeve 1150 are engaged with the same number of male serrations 1145g formed at the outer periphery of the nut 1145. Therefore, the two can rotate in unison. Therefore, even when a high torque is transmitted between the sleeve 1150 and the nut 1145, a relative slip between the two can be suppressed. The other construction is similar to that of the embodiment of FIG. 11, and therefore explanation thereof will be omitted.

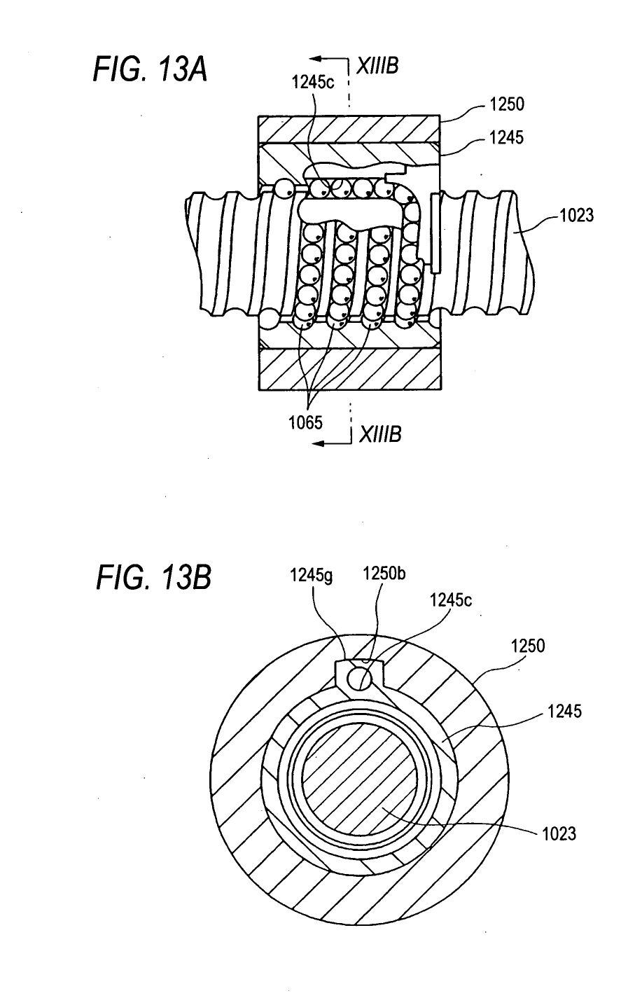

FIG. 13A is an axial cross-sectional view of a ball screw mechanism of a seventh embodiment, and FIG. 13B is a view in which a nut of FIG. 13A is cut along the line XIIIB-XIIIB, and is seen in a direction of arrows, but balls are omitted. In FIG. 13, a protruding portion 1245g which is a convex portion is formed on an outer periphery of the nut 1245 in a manner to cover a circulating passage 1245c (that is, in such a manner that at least part thereof is disposed radially outwardly of the circulating passage), and extends in an axial direction. On the one hand, a groove 1250b which is a concave portion and corresponds to the protruding portion 1245g is formed in an inner periphery of a sleeve 1250. The nut 1245 is inserted in and fixed to the sleeve 1250 in such a manner that the protruding portion 1245g is engaged in the groove 1250b. Therefore, the two can rotate in unison. Therefore, even when a high torque is transmitted between the sleeve 1250 and the nut 1245, a relative slip between the two can be suppressed, and besides a wall thickness of the nut 1245 can be reduced. The other construction is similar to that of the embodiment of FIG. 11, and therefore explanation thereof will be omitted.

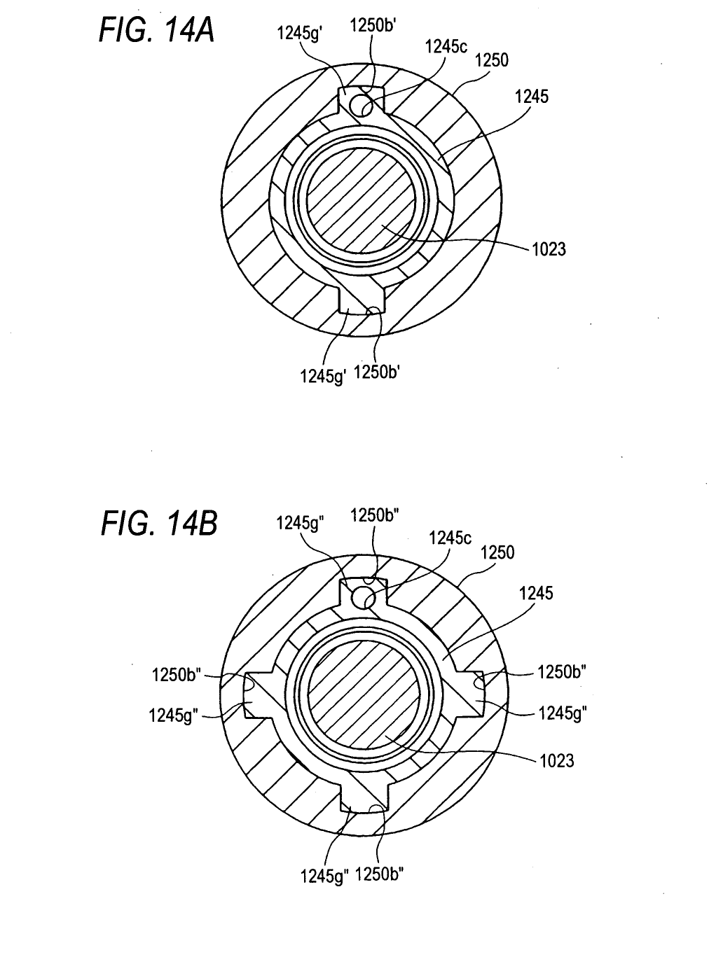

Incidentally, the protruding portion is not always limited to one. For example, two protruding portions 1245g′ opposed to respective grooves 1250b′ can be provided 180 degrees out of phase as in a modified example shown in FIG. 14A, or four protruding portions 1245g″ opposed to respective grooves 1250b″ can be provided 90 degrees out of phase as in a modified example shown in FIG. 14B. However, the number and the phase are not limited to these.

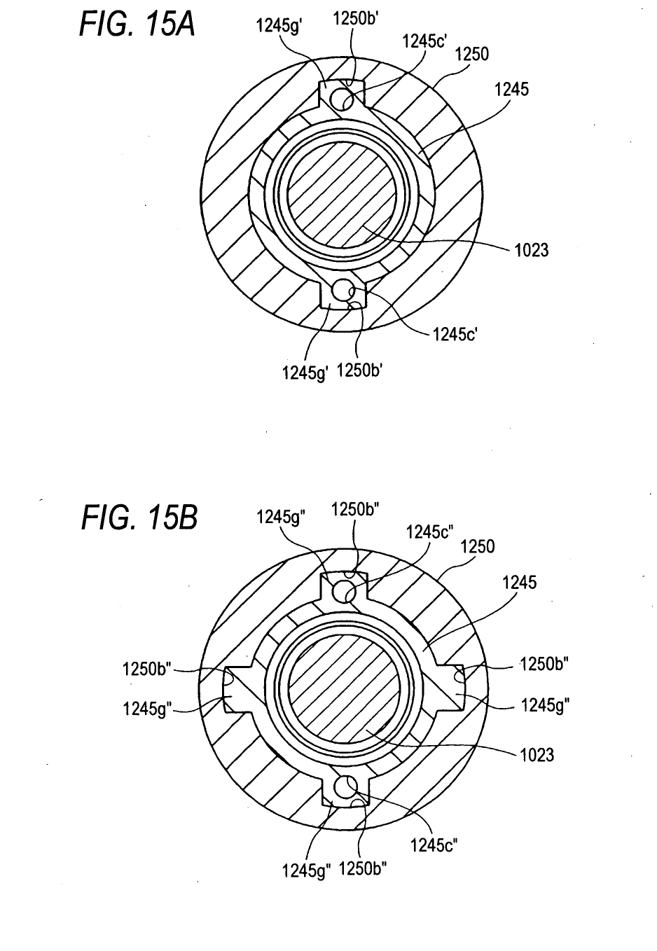

Furthermore, in some cases, a nut has two circulating passages. Therefore, for example, two protruding portions 1245g′ opposed to respective grooves 1250b′ can be provided in a manner to cover circulating passages 1245c′ provided 180 degrees out of phase as in a modified example shown in FIG. 15A, or four protruding portions 1245g″ (two of which are provided to cover circulating passages 1245c″ provided 180 degrees out of phase) opposed to respective grooves 1250b″ can be provided 90 degrees out of phase as in a modified example shown in FIG. 15B.

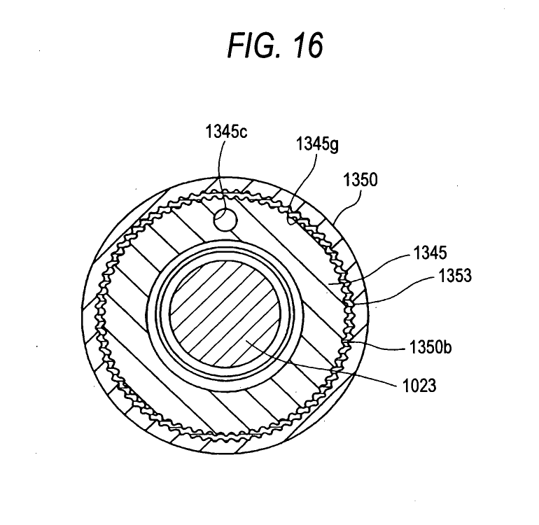

FIG. 16 is a cross-sectional view of a ball screw mechanism of an eighth embodiment in a direction perpendicular to an axis thereof, but balls are omitted. In FIG. 16, outer teeth 1345g are formed on an outer periphery of a nut 1345 over the entire periphery thereof, and on the one hand inner teeth 1350b are formed on an inner periphery of a sleeve 1350 over the entire periphery thereof. An outer diameter of the nut 1345 is smaller than an inner diameter of the sleeve 1350, and therefore the outer teeth 1345g and the inner teeth 1350b are not directly engaged with each other, and a cylindrical toothed belt 1353 is inserted between the outer teeth and the inner teeth. The toothed belt 1353 has teeth formed on each of its inner and outer peripheries, and its inner teeth are meshed with the outer teeth 1345g, and its outer teeth are meshed with the inner teeth 1350b. Therefore, the sleeve 1350 and the nut 1345 can rotate in unison. In this embodiment, the toothed belt 1353 functions as an elastic body, and therefore an impact force transmitted between the sleeve 1350 and the nut 1345 can be relieved. Incidentally, instead of the toothed belt 1353, rubber or a resin is fused between the sleeve 1350 and the nut 1345 to function as an elastic body.

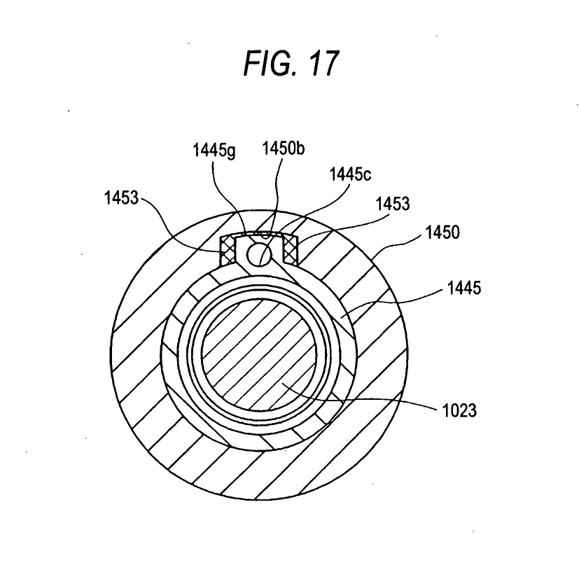

FIG. 17 is a cross-sectional view of a ball screw mechanism of a ninth embodiment in a direction perpendicular to an axis thereof, but balls are omitted. In FIG. 17, a protruding portion 1445g which is a convex portion is formed on an outer periphery of a nut 1445 in a manner to cover a circulating passage 1445c (that is, in such a manner that at least part thereof is disposed radially outwardly of the circulating passage), and extends in an axial direction. On the one hand, a groove 1450b which is a concave portion and corresponds to the protruding portion 1445g is formed in an inner periphery of a sleeve 1450. A width of the groove 1450b is larger than a width of the protruding portion 1445g, and a buffer member 1453 (preferably made of rubber or a resin) is disposed in two spaces which are formed respectively at opposite sides in a peripheral direction when the protruding portion 1445g is engaged in the groove 1450b. When a torque transmission occurs between the sleeve 1450 and the nut 1445, the protruding portion 1445g which is the convex portion moves relative to and within the groove 1450b, and even if an impact force develops at this time, the buffer member 1453 relieves this impact force.

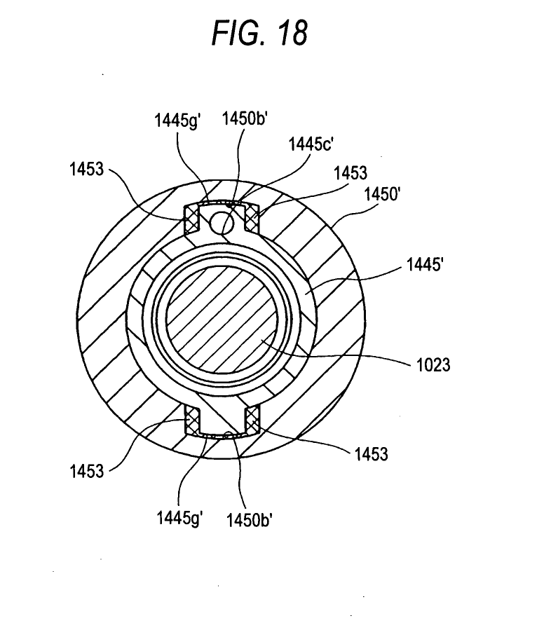

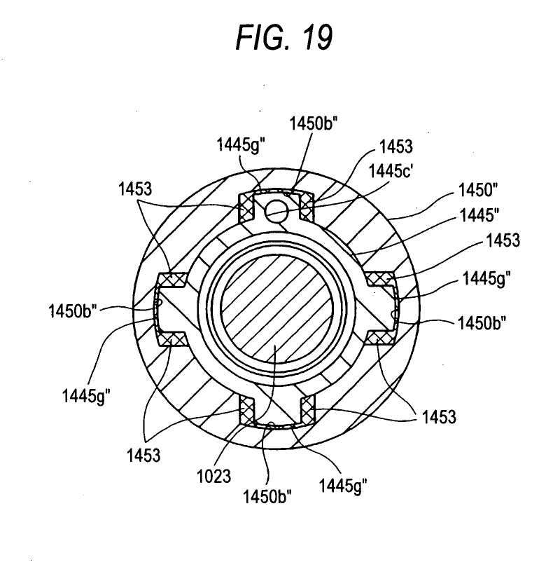

Incidentally, the protruding portion is not always limited to one. For example, two protruding portions 1445g′ opposed to respective grooves 1450b′ can be provided 180 degrees out of phase as in a modified example shown in FIG. 18, or four protruding portions 1445g″ opposed to respective grooves 1450b″ can be provided 90 degrees out of phase as in a modified example shown in FIG. 19. However, the number and the phase are not limited to these.

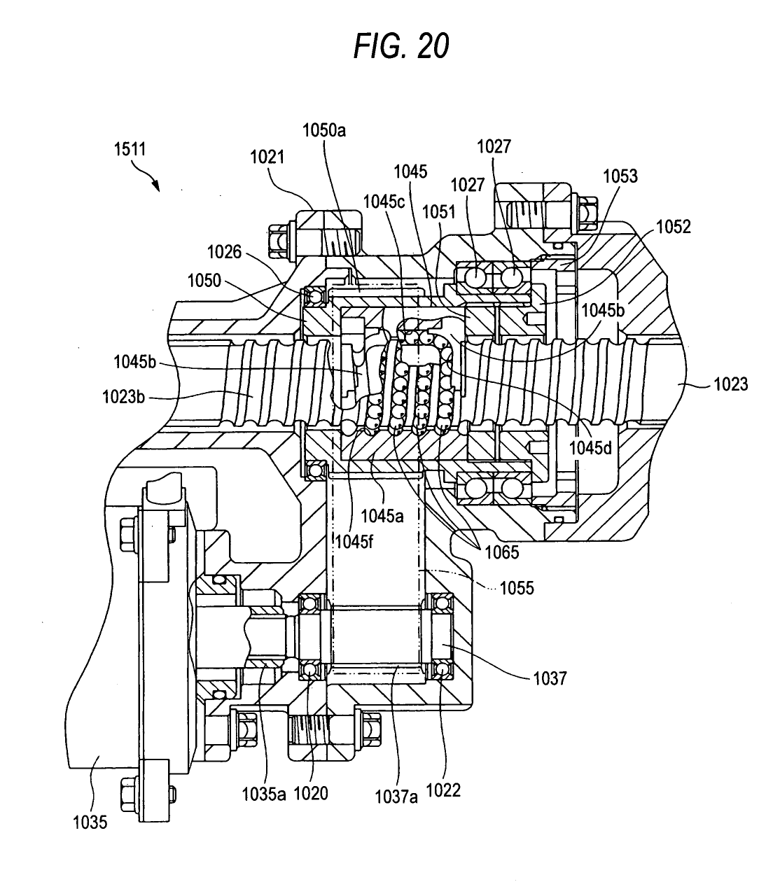

FIG. 20 is a cross-sectional view of an important portion of an electric power steering apparatus 1511 of a tenth embodiment. In this embodiment, only those points different from the embodiment shown in FIG. 11 will be described, and with respect to common constructions, identical reference numerals will be applied, and explanation thereof will be omitted.

In this embodiment, instead of omitting the intermediate shaft, there is provided a toothed belt 1055 engaged with a gear portion 1037a of a drive gear 1037 and a driven gear portion 1050a of a sleeve 1050. Therefore, when the drive gear portion 1037a rotates together with an output shaft 1035a of an electric motor 1035, the driven gear portion 1050a is rotated at a predetermined reduction ratio via the toothed belt 1055. As a result, the sleeve 1050 and a nut 1045 also rotate, and therefore power of the electric motor 1035 can be transmitted to a screw shaft 1023. Incidentally, a chain may be used instead of the toothed belt. Furthermore, it is needless to say that the ball screw mechanisms of the modified examples of FIGS. 12 to 19 can be used.

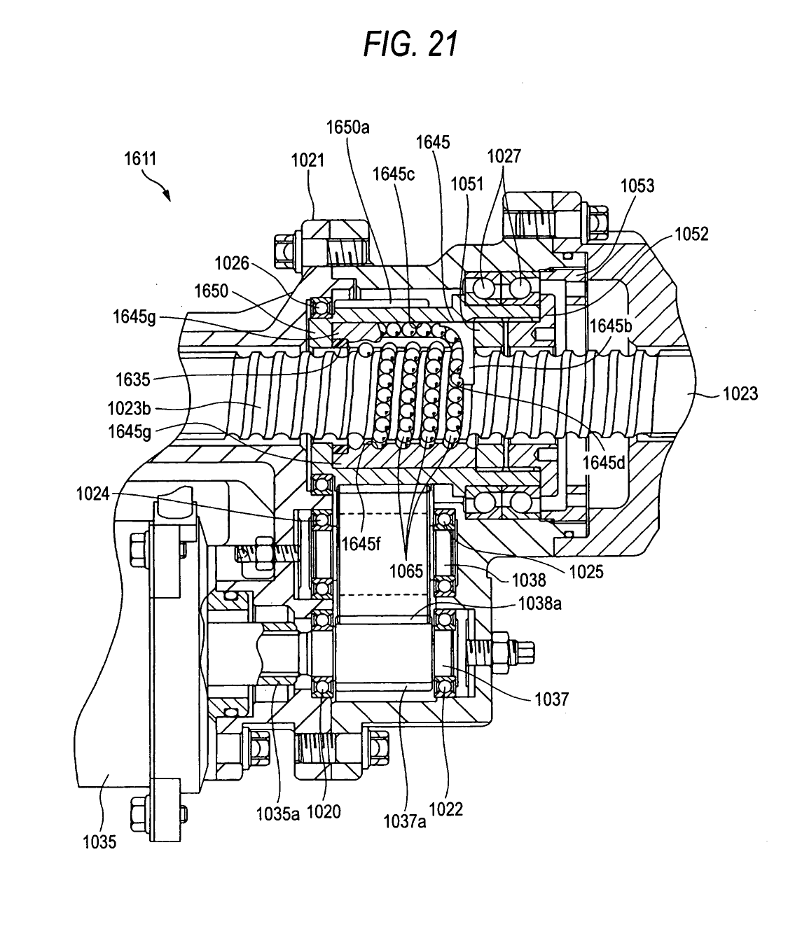

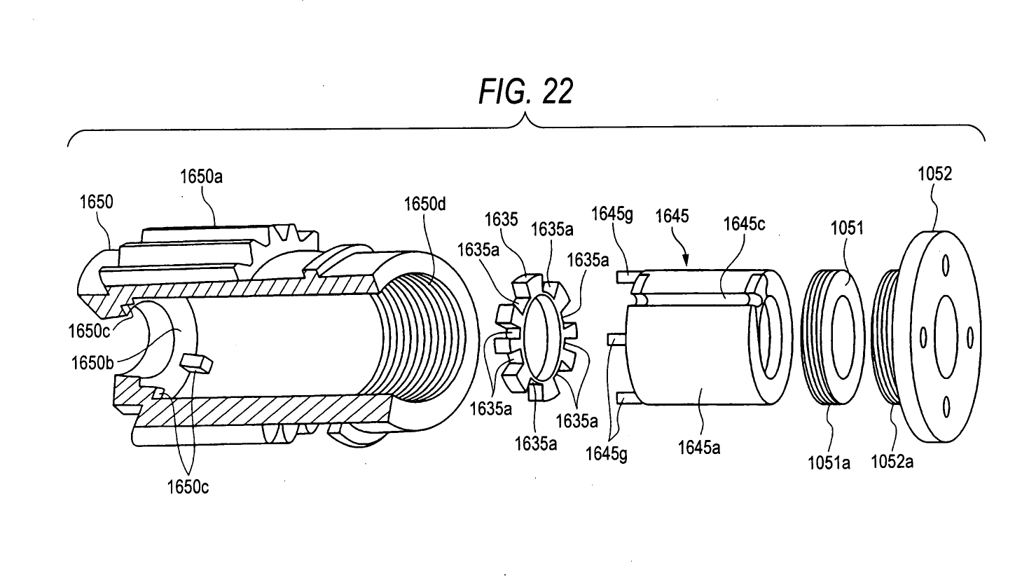

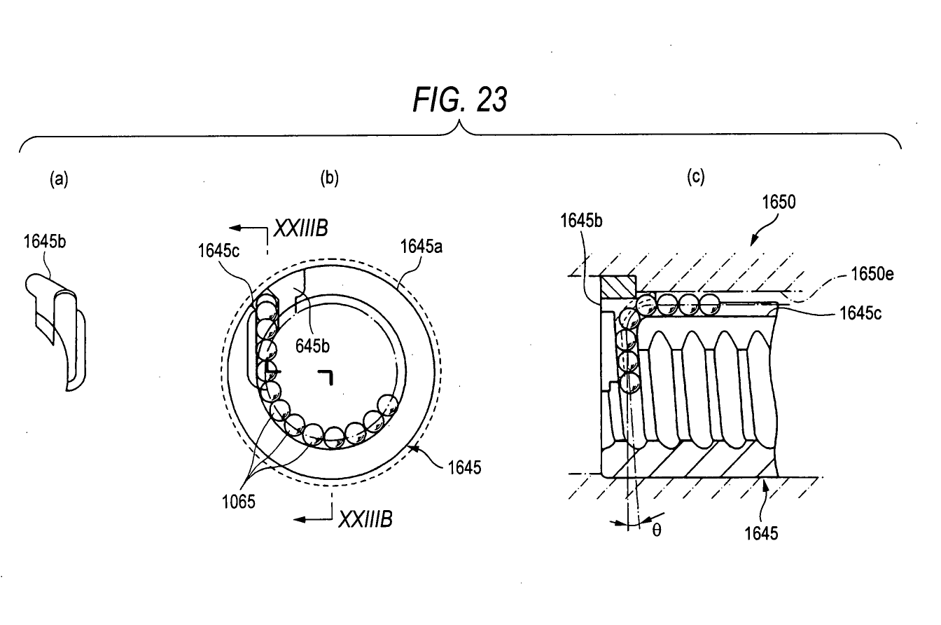

FIG. 21 is a cross-sectional view of an important portion of an electric power steering apparatus 1611 of an eleventh embodiment. FIG. 22 is an exploded perspective view of a nut and a sleeve of this embodiment, but bearings are omitted. FIG. 23(a) is a view showing an end surface of the nut of this embodiment, FIG. 23(b) is a view in which the construction of FIG. 23(a) is cut along the line XXIIIB-XXIIIB, and is seen in a direction of arrows, and FIG. 23(c) is a view showing a deflector. In this embodiment, only those points different from the embodiment shown in FIG. 11 will be described, and with respect to common constructions, identical reference numerals will be applied, and explanation thereof will be omitted.

In this embodiment, the nut as well as the sleeve is different in construction. More specifically, as shown in FIG. 22, four square pillar-like projections 1650c are formed on a bottom wall 1650b of the sleeve 1650 at intervals of 90 degrees in a peripheral direction, and project in an axial direction (extend from a bottom surface in the axial direction).

Further, four square pillar-like projections 1645g are formed on that end surface of a body 1645a of the nut 1645, opposed to the sleeve 1650, at intervals of 90 degrees in a peripheral direction, and project in an axial direction. A ring-like first buffer body (made of rubber or a resin) 1635 is disposed between the nut 1645 and the sleeve 1650. The first buffer body 1635 has eight groove portions 1635a formed at intervals of 45 degrees in a peripheral direction. The groove portions 1635a correspond in configuration to the projections 1645g, 1650c.

At the time of the assembling, the projections 1645g of the nut 1645 are arranged to pass through the groove portions 1635a of the first buffer body 1635, and also the projections 1650c of the sleeve 1650 are arranged to pass through the remaining groove portions 1635a of the first buffer body 1635. Namely, the first buffer body 1635 is disposed between the projections 1645g, 1650c alternately arranged in the peripheral direction. In this condition, by threadedly engaging an externally-threaded portion 1051a of a threaded member 1051 with an internally-threaded portion 1650d formed on the inner periphery of the sleeve 1650 at an end portion thereof, the nut 1645 and the sleeve 1650 are assembled together so as to rotate in unison. Incidentally, bearings 1027, 1027 (see FIG. 21) are fitted on the outer periphery of the sleeve 1650, and an externally-threaded portion 1052a of an inner ring holder 1052 is threadedly engaged with the internally-threaded portion 1650d, and by doing so, the bearings 1027, 1027 can be mounted.

In this embodiment, the first buffer body 1635 is disposed between the projections 1645g of the nut 1645 and the projections 1650c of the sleeve 1650, and therefore by deformation of the first buffer body 1635 at the time of transmitting a torque, vibrations and noises can be suppressed as buffering effects at the time of transmitting the torque, and besides a jarring motion between the nut 1645 and the sleeve 1650 in the axial direction can be eliminated, and furthermore a misalignment-suppressing effect can be expected.

Incidentally, for example, in case recesses corresponding to the projections 1650c of the sleeve 1650 (or the projections 1645g of the nut 1645) are formed in the nut 1645 (or the sleeve 1650), and are engaged in these projections, similar functions can be achieved.

Further, as shown in FIG. 22, an axial groove 1645c is formed in the outer periphery of the body 1645a of the nut 1645. When the nut 1645 is fitted in the sleeve 1650 indicated by a dot-and-dash line in FIG. 23(b), the axial groove 1645c is covered at its outer side with an inner peripheral surface 1650e of the sleeve to form a circulating passage. In the above-mentioned embodiments, any of the circulating passages extends through the nut body, and a long drill is required to form it, and the processing is relatively difficult. On the other hand, in this embodiment, the axial groove 1645c can be easily formed by milling or other processing. In the case of the through hole-type circulating passage, the nut body has the increased wall thickness as indicated by a broken line in FIG. 23(a). However, in this embodiment, the wall thickness of the body 1645a can be reduced as indicated by solid lines, and there can be provided the ball screw mechanism in which acceleration and deceleration can be easily effected while suppressing inertia mass.

In this embodiment, also, as in the above embodiments, the deflector 1645b shown in FIG. 23(c) picks up balls 1065, rolling in a rolling passage in the nut 1645, in a tangential direction of the rolling passage as shown in FIG. 23(a), and also picks up the balls in a direction of a lead angle θ as shown in FIG. 23(b) to feed the balls to the axial groove 1645c.

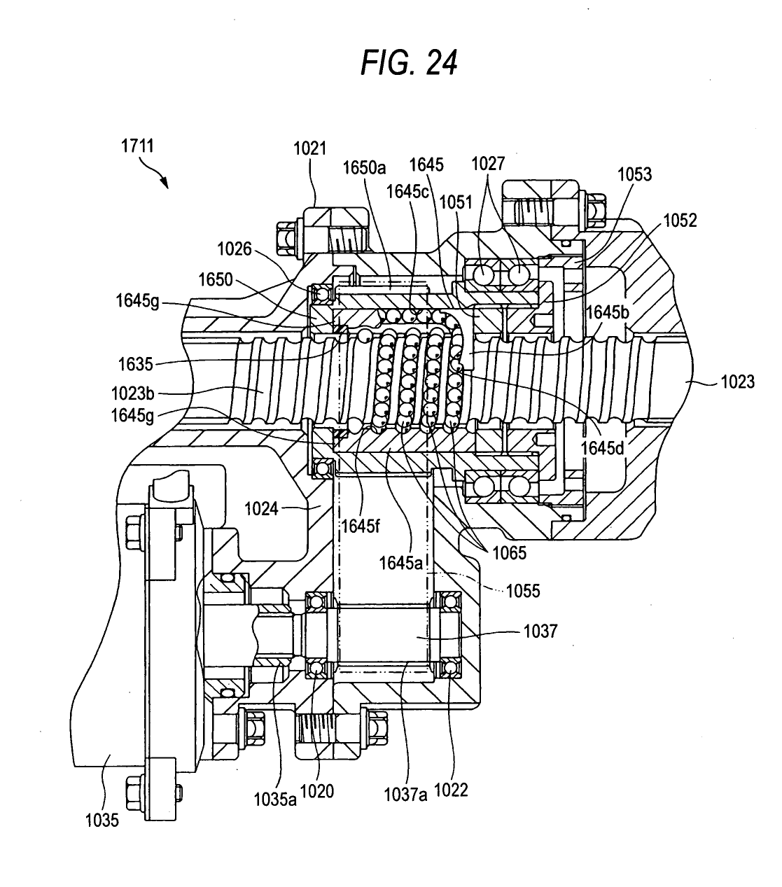

FIG. 24 is a cross-sectional view of an important portion of an electric power steering apparatus 1711 of a twelfth embodiment. In this embodiment, only those points different from the embodiment shown in FIG. 21 will be described, and with respect to common constructions, identical reference numerals will be applied, and explanation thereof will be omitted.

In this embodiment, instead of omitting the intermediate shaft, there is provided a toothed belt 1055 engaged with a gear portion 1037a of a drive gear 1037 and a driven gear portion 1650a of a sleeve 1650. Therefore, when the drive gear portion 1037a rotates together with an output shaft 1035a of an electric motor 1035, the driven gear portion 1650a is rotated at a predetermined reduction ratio via the toothed belt 1055. As a result, the sleeve 1650 and a nut 1645 also rotate, and therefore power of the electric motor 1035 can be transmitted to a screw shaft 1023. Incidentally, a chain may be used instead of the toothed belt.

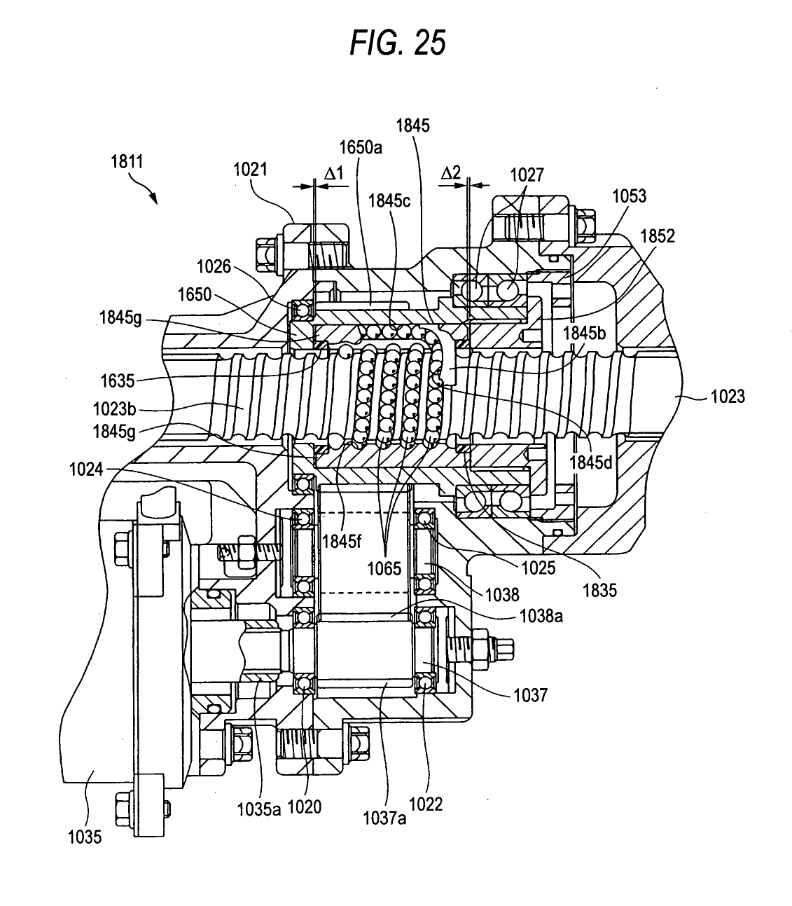

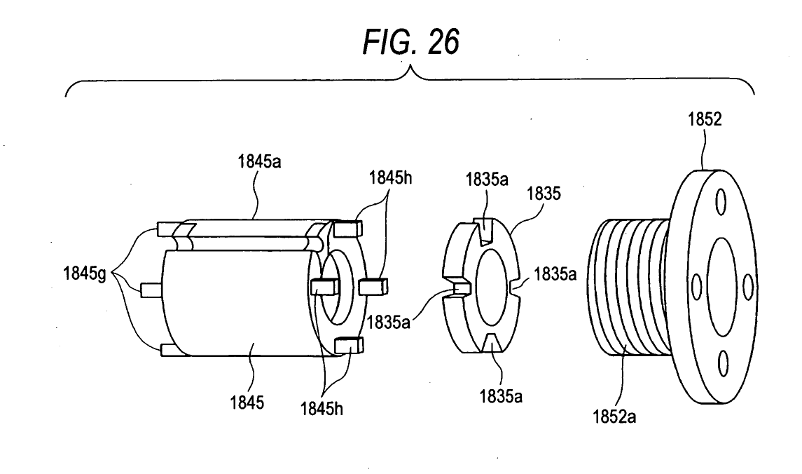

FIG. 25 is a cross-sectional view of an important portion of an electric power steering apparatus 1811 of a thirteenth embodiment. FIG. 26 is an exploded perspective view showing a nut and an inner ring holder of this embodiment. In this embodiment, only those points different from the embodiment shown in FIG. 21 will be described, and with respect to common constructions, identical reference numerals will be applied, and explanation thereof will be omitted.

In this embodiment, as shown in FIG. 26, four square pillar-like projections 1845h are formed on that end surface of the nut 1845 close to the inner ring holder 1852, and are disposed at intervals of 90 degrees in a peripheral direction, and project in an axial direction.

Incidentally, as in the above embodiments, four square pillar-like projections 1845g are formed on that end surface of the nut 1845 close to a bottom wall of a sleeve, and are disposed at intervals of 90 degrees in the peripheral direction, and project in the axial direction.

A ring-like second buffer body (made of rubber or a resin) 1835 is disposed between the nut 1845 and the inner ring holder 1852. The second buffer body 1835 has four groove portions 1835a formed at intervals of 90 degrees in a peripheral direction. The groove portions 1835a correspond in configuration to the projections 1845h.

At the time of the assembling, as shown in FIG. 25, the projections 1845h of the nut 1845 are arranged to be fitted respectively in the groove portions 1835a of the second buffer body 1835, but the projections 1845h will not extend through the second buffer body 1835, and a gap A2 is formed between the projection 1845h and an end surface of the inner ring holder 1852. On the one hand, as shown in FIG. 25, the projections 1845g of the nut 1845 are arranged to fitted respectively in groove portions of a second buffer body 1835, but the projections 1845g will not extend through the first buffer body 1635, and a gap A1 is formed between the projection 1845g and a bottom surface of the sleeve 1650. In this condition, bearings 1027, 1027 (see FIG. 25) are fitted on the outer periphery of the sleeve 1650, and an externally-threaded portion 1852a of the inner ring holder 1852 is threadedly engaged with the sleeve 1650, and by doing so, the bearings 1027, 1027 can be mounted.

In this embodiment, the gap A2 is formed between the nut 1845 and the inner ring holder 1852, and also the gap A1 is formed between the nut and the sleeve 1650, and therefore by elastically deforming the first buffer body 1635 or the second buffer body 1835, the nut 1845 can be moved in the axial direction, so that the above-mentioned buffering effects can be enhanced. And besides, deflectors 1845b provided respectively at opposite ends of a body 1845a of the nut 1845 are held respectively by the first buffer body 1635 and the second buffer body 1835, and therefore when a ball 1065 impinges on the deflector 1845b during the operation, noises and vibrations thereof can be suppressed and absorbed.

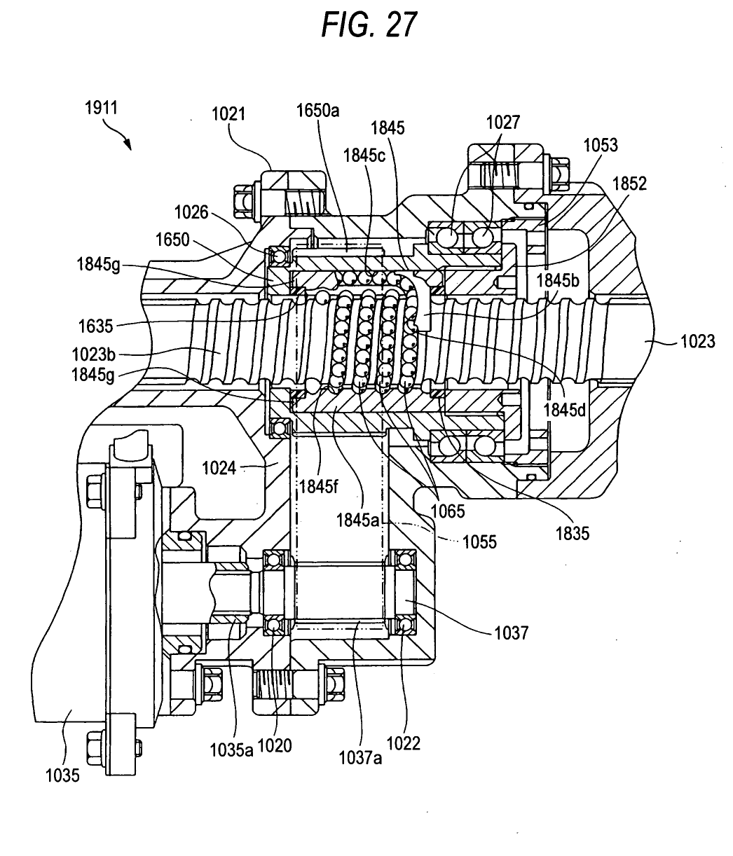

FIG. 27 is a cross-sectional view of an important portion of an electric power steering apparatus 1911 of a fourteenth embodiment. In this embodiment, only those points different from the embodiment shown in FIG. 25 will be described, and with respect to common constructions, identical reference numerals will be applied, and explanation thereof will be omitted.

In this embodiment, instead of omitting the intermediate shaft, there is provided a toothed belt 1055 engaged with a gear portion 1037a of a drive gear 1037 and a driven gear portion 1650a of a sleeve 1650. Therefore, when the drive gear portion 1037a rotates together with an output shaft 1035a of an electric motor 1035, the driven gear portion 1650a is rotated at a predetermined reduction ratio via the toothed belt 1055. As a result, the sleeve 1650 and a nut 1845 also rotate, and therefore power of the electric motor 1035 can be transmitted to a screw shaft 1023. Incidentally, a chain may be used instead of the toothed belt.

Incidentally, in the above embodiments, the projections of the nut and the sleeve, or the projections and the recesses, may be directly engaged with each other without interposing the first buffer body therebetween so that a torque transmission can be effected.

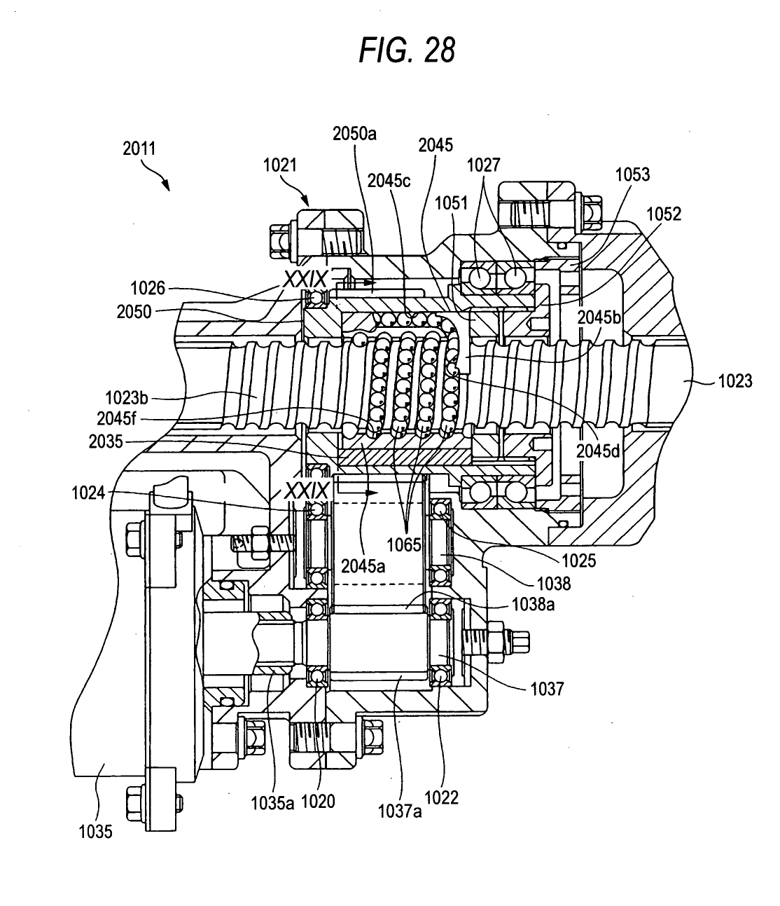

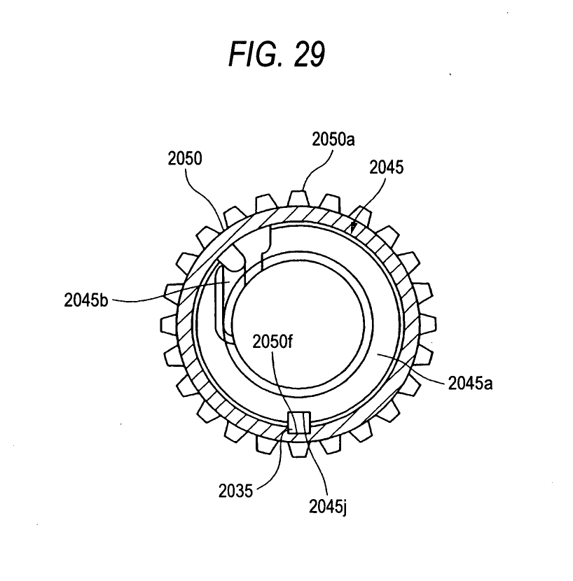

FIG. 28 is a cross-sectional view of an important portion of an electric power steering apparatus 2011 of a fifteenth embodiment. FIG. 29 is a view in which the construction of FIG. 28 is cut along the line XXIX-XXIX, and is seen in a direction of arrows, but a screw shaft and balls are omitted. In this embodiment, only those points different from the embodiment shown in FIG. 11 will be described, and with respect to common constructions, identical reference numerals will be applied, and explanation thereof will be omitted.

In this embodiment, a nut and a sleeve are interconnected by a key. More specifically, in FIG. 29, an axially-extending key groove 2045j is formed in an outer peripheral surface of the nut 2045, and an axially-extending key groove 2050f is formed in an inner peripheral surface of the sleeve 2050 in opposed relation to the key groove 2045j. The square pillar-like key 2035 is disposed in a space formed by the key grooves 2045j, 2050f, and therefore a torque can be transmitted from the sleeve 2050 to the nut 2045, utilizing a shearing force of the key 2035.

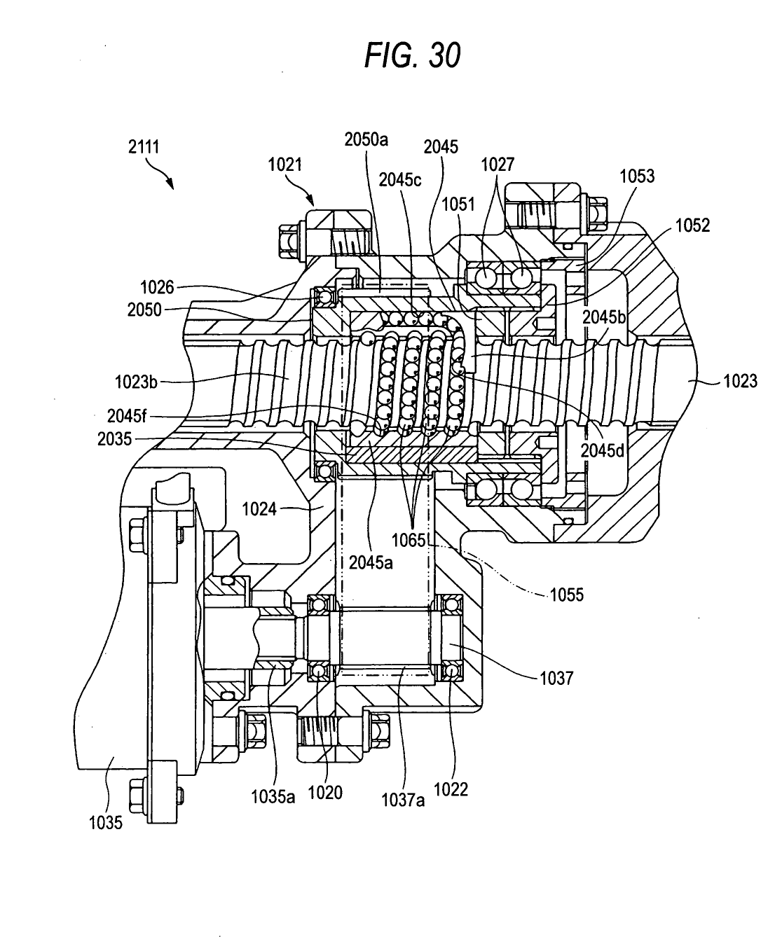

FIG. 30 is a cross-sectional view of an important portion of an electric power steering apparatus 2111 of a sixteenth embodiment. In this embodiment, only those points different from the embodiment shown in FIG. 28 will be described, and with respect to common constructions, identical reference numerals will be applied, and explanation thereof will be omitted.

In this embodiment, instead of omitting the intermediate shaft, there is provided a toothed belt 1055 engaged with a gear portion 1037a of a drive gear 1037 and a driven gear portion 2050a of a sleeve 2050. Therefore, when the drive gear portion 1037a rotates together with an output shaft 1035a of an electric motor 1035, the driven gear portion 2050a is rotated at a predetermined reduction ratio via the toothed belt 1055. As a result, the sleeve 2050 and a nut 2045 also rotate, and therefore power of the electric motor 1035 can be transmitted to a screw shaft 1023. Incidentally, a chain may be used instead of the toothed belt.

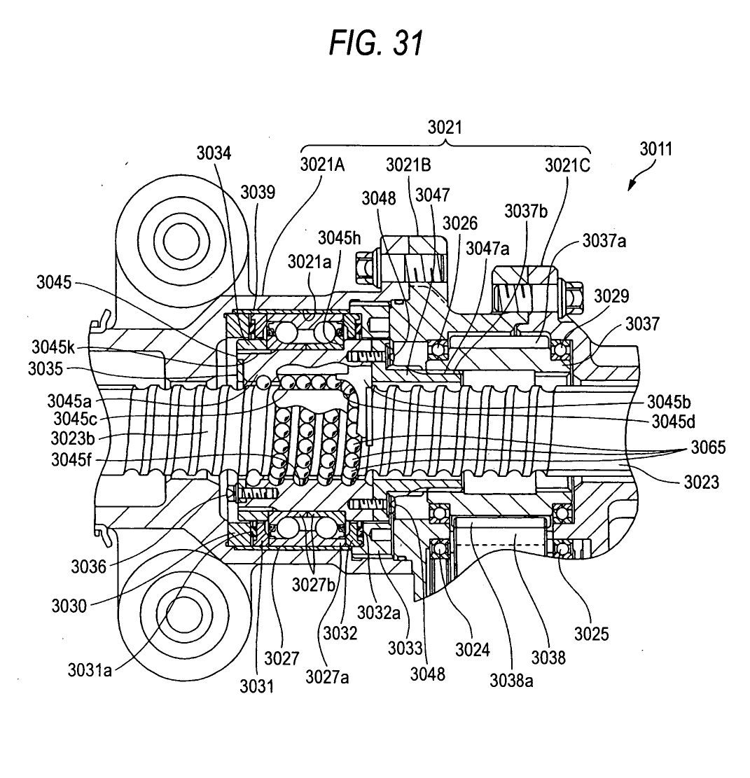

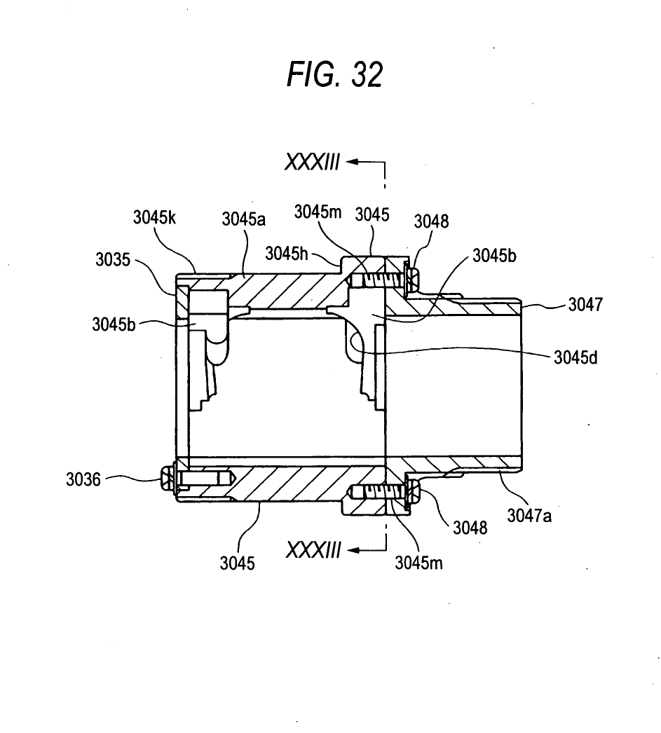

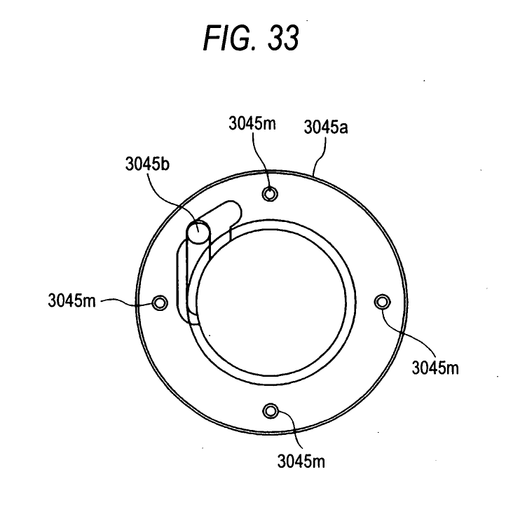

FIG. 31 is a cross-sectional view of an important portion of an electric power steering apparatus of a seventeenth embodiment. FIG. 32 is a cross-sectional view of a nut and a fixing member in an assembled condition, and FIG. 33 is a view in which the nut of FIG. 32 is seen in a direction of arrows XXXIII.

In FIG. 31, the electric power steering apparatus 3011 has a housing 3021 fixed to a vehicle body not shown. The housing 3021 is divided into three sections in FIG. 31, and comprises members 3021A, 3021B, 3021C fastened together into a unitary form by bolts. A rack shaft 3023 extends horizontally through the housing 3021, and is supported so as to be moved in an axial direction. Although not shown, a pinion is formed at a lower end of an input shaft connected to a steering wheel, and is in mesh with rack teeth of the rack shaft 3023, and the rack shaft 3023 is moved left and right in the drawings by rotation of the input shaft. Opposite ends of the rack shaft 3023 are connected to a tie rod (not shown) of a steering mechanism.

An electric motor (not shown) is mounted on the housing 3021 in such a manner that its axis is parallel to the rack shaft 3023. Power of the electric motor is transmitted to an intermediate shaft 3038 only part of which is shown in FIG. 31. The intermediate shaft 3038 is rotatably supported on the housing 3021 by bearings 3024, 3025, and has an intermediate gear portion 3038a at a portion thereof interposed between the bearings 3024, 3025.

The nut 3045 is disposed around the periphery of the rack shaft 3023, and is rotatably supported on the housing 3021 by a double row angular contact ball bearing 3027. This will now be described more specifically. A thin-wall cylindrical sleeve 3039 is fittingly disposed within an inner hole 3021a of the member 3021A of the housing 3021. And, a ring-like member 3030, a first buffer member 3031, an outer ring 3027a of the double row angular contact ball bearing 3027 and a second buffer member 3032 are arranged in this order from a bottom surface (the left side in FIG. 31) of the inner hole 3021a, and are fixed by a lock member 3033 threadedly engaged with the member 3021A. The first buffer member 3031 has an elastic body 3031a abutting against the ring-like member 3030. And, the second buffer member 3032 has an elastic body 3032a abutting against the lock member 3033. By elastic deformation of the elastic bodies 3031a, 3032a, the double row angular contact ball bearing 3027 can move together with the nut 3045 in the axial direction within a limited range. The outer ring 3027a is fitted in an inner peripheral surface of the sleeve 3039.

An inner ring 3027b, 3027b of the double row angular contact ball bearing 3027, which is divided in two sections juxtaposed in the axial direction, is fitted on an outer peripheral surface of the nut 3045, and its right end (in the drawings) abuts against an outer peripheral step portion 3045h formed at that portion of the nut 3045 near to a right end thereof. And, the left end (in the drawings) of the inner ring 3027b, 3027b abuts against a right end of a threaded member 3034, so that a preload is applied to the inner ring. The threaded member 3034 is threaded on a threaded portion 3045K formed on the outer peripheral surface of the nut 3045. The preload can be adjusted by the amount of threading of the threaded member 3034.

In FIG. 32, the nut 3045 includes a central body 3045a of a hollow cylindrical shape, and deflectors 3045b provided respectively at opposite ends thereof. The body 3045a forms a circulating passage 3045c extending therethrough in an axial direction. Each deflector 3045b forms a pick-up piece 3045d which picks up rolling balls 3065 in a tangential direction of a rolling passage and also in a direction of a lead angle thereof to return the balls to the circulating passage 3045c. The screw shaft 3023, the nut 3045 and the balls 3065 form a ball screw mechanism (power transmission mechanism).

In FIG. 32, the deflector 3045b is disposed at a left end of the body 3045a of the nut 3045, and is fixed by a doughnut disk-shaped holding plate 3035 screw-fastened to the body 3045a by a screw 3036. On the one hand, the deflector 3045b is disposed at a right end of the body 3045a of the nut 3045, and is fixed by a left end surface of the cylindrical fixing member 3047 screw-fastened to the nut 3045 by four screws 3048, and the two are rotated in unison. As shown in FIG. 33, the end surface of the body 3045a is flat except its portion surrounding the deflector 3045b, and therefore an arbitrary number of screw holes 3045m into which the screw 3048 are threaded can be provided at arbitrary positions.

A male serration portion 3047a is formed on that portion of the fixing member 3047 disposed near to the right end thereof. Incidentally, the fixing member 3047 is separate from the nut 3047, and therefore an outer diameter of the male serration portion 3047a can be arbitrarily determined, and the degree of freedom of design is enhanced.

In FIG. 32, a hollow driven gear 3037 which is a driven member is rotatably supported at its opposite ends on the housing 3021 by bearings 3026, 3029, and has a driven gear portion 3037a in mesh with the intermediate gear portion 3038a, and also has a female serration portion 3037b formed on the inner periphery of a left end thereof. The intermediate gear portion 3038a and the driven gear portion 3037a form a gear pair. Incidentally, the nut 3045, etc., can be mounted from the right side in the drawings in a condition in which the members 3021A, 3021B of the housing 3021 are removed.

By engaging the female serration portion 3037b of the driven gear 3037 with the male serration portion 3047a of the fixing member 3047, the driven gear 3037 and the fixing member 3047 are interconnected in such a manner that the two can move relative to each other in an axial direction, but can not rotate relative to each other in a rotational direction. The driven gear 3037 and the fixing member 3047 are arranged so as to move relative to each other in the axial direction in order that the elastic bodies 3031a and 3032a can achieve the buffering effect.

In FIG. 31, a male screw groove 3023b is formed in part of the outer peripheral surface of the rack shaft 3023 integral with the screw shaft (A separate part may be connected). The nut 3045 is disposed around the periphery of the male screw groove 3023b, and a female screw groove 3045f is formed in the inner peripheral surface of the body 3045a opposed to the male screw groove 3023b. A number of balls (rolling members) 3065 are rollably disposed within a spiral space (rolling passage) formed by the male screw groove 3023b and the female screw groove 3045f.

The operation of this embodiment will be explained. Although not shown, when the driver rotates the steering wheel, its rotational force is transmitted to the input shaft. When the input shaft rotates, the rack teeth pinion-meshed therewith are pushed, and the rack shaft 3023 is moved in the axial direction to drive the steering mechanism (not shown) via the tie rod, thereby effecting the steering of vehicle wheels.

At this time, a torque sensor not shown detects a steering torque, and in accordance with its amount, a CPU not shown supplies electric power to the electric motor, and therefore the driven gear portion 3037a meshed via the intermediate gear portion 3038a is rotated at a predetermined reduction ratio. Therefore, the rotational power is transmitted from the driven gear 3037 to the nut 3045 via the fixing member 3047, and a rotational motion of the nut 3045 is converted into an axial movement of the rack shaft 3023 via the balls 3065. The ball 3065, rolled to one end of the rolling passage, is picked up by the deflector 3045b, and is returned to the other end through the circulating passage 3045c. An assist steering force can be outputted, using the axial force of the rack shaft 3023.

In the electric power steering apparatus 3011 of this embodiment, the fixing member 3047 has the function of fixing the deflector 3045b to the body 3045a of the nut 3045, and also has the function of transmitting power from the driven gear 3037 to the nut 3045, and therefore the number of the parts is reduced, and the efficiency of the assembling is enhanced, and furthermore a space-saving design can be achieved. Therefore, the power is directly transmitted to the body 3045a, and therefore it is not necessary to increase the outer diameter of the nut 3045, and any power is not transmitted to the deflector 3045b, and deformation and breakage due to the power transmission will not occur.

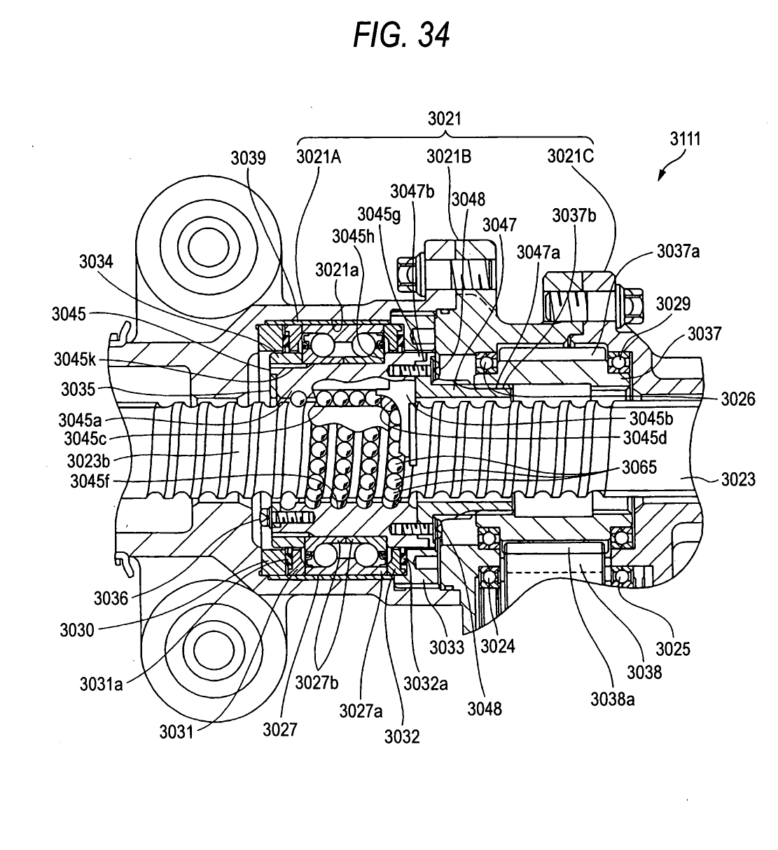

FIG. 34 is a cross-sectional view showing an electric power steering apparatus 3111 of an eighteenth embodiment. In this embodiment, only those points different from the embodiment shown in FIGS. 31 to 33 will be described, and with respect to common constructions, identical reference numerals will be applied, and explanation thereof will be omitted.

In FIG. 34, an annular portion 3045g is formed on a right end surface of a body 3045a of a nut 3045 in coaxial relation thereto. On the one hand, a reduced-diameter cylindrical portion 3047b, having an outer diameter generally equal to an inner diameter of the annular portion 3045g, is coaxially formed on a left end surface of a fixing member 3047 opposed to this annular portion. Therefore, by fitting the reduced-diameter cylindrical portion 3047b into the annular portion 3045g, the two are positioned relative to each other in a radial direction, that is, by connecting the body 3045a and the fixing member 3047 together coaxially with each other, run-out of the nut 3045 during high-speed rotation, etc., can be suppressed. The annular portion 3045g and the reduced-diameter cylindrical portion 3047b form a spigot joint.

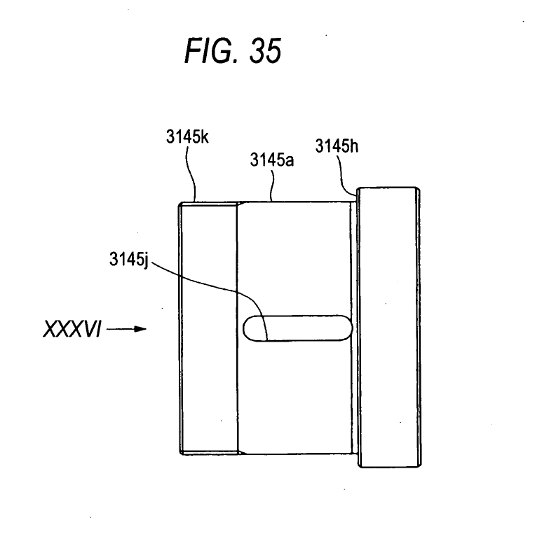

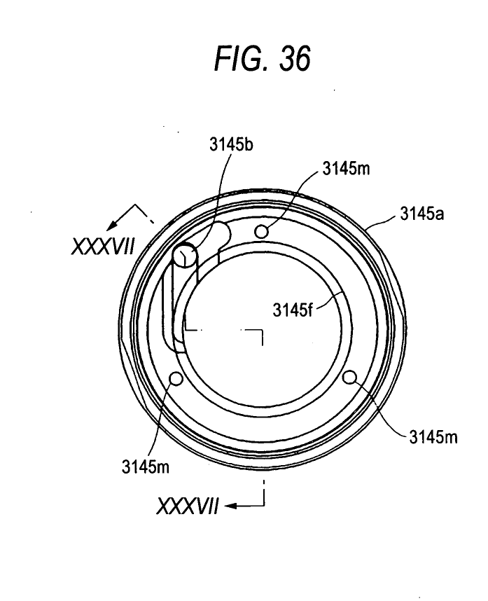

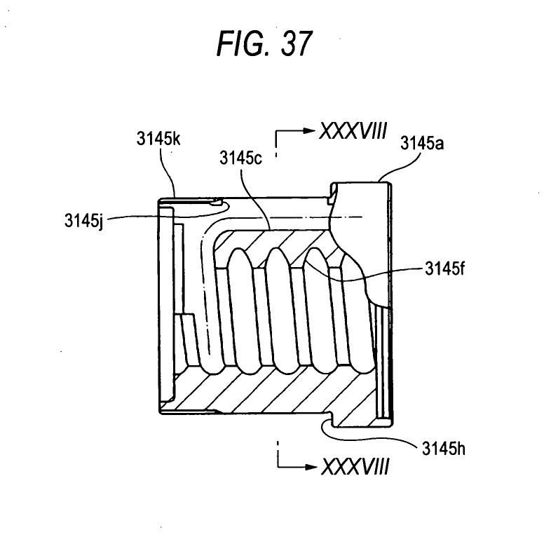

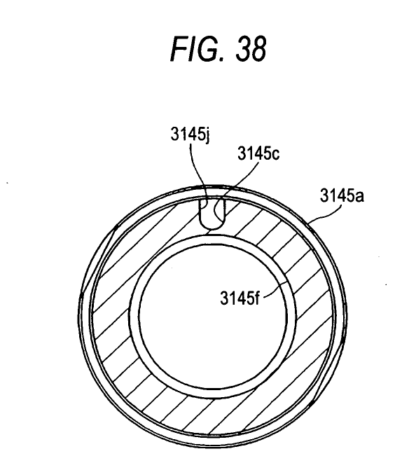

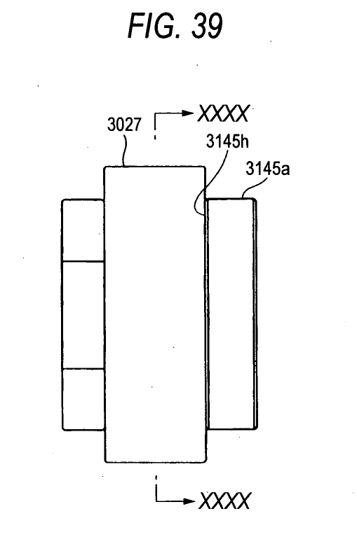

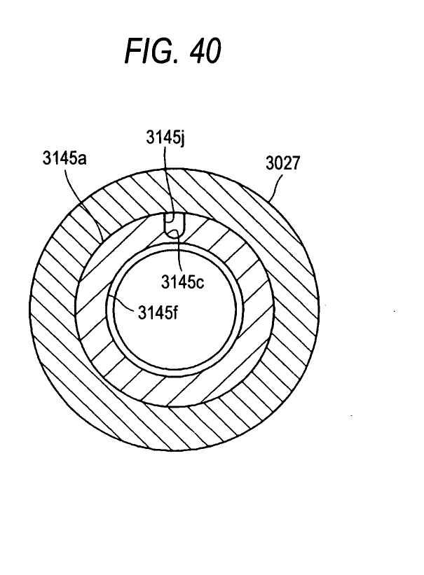

FIG. 35 is a top plan view of a body of a nut of a further embodiment which can be used in the electric power steering apparatuses shown in FIGS. 31 and 34, FIG. 36 is a view in which the nut body shown in FIG. 35 is seen in a direction of arrow XXXVI, FIG. 37 is a view in which the nut body shown in FIG. 36 is cut along the line XXXVII-XXXVII, and is seen in a direction of arrows, and FIG. 38 is a view in which the nut body shown in FIG. 37 is cut along the line XXXVIII-XXXVIII, and is seen in a direction of arrows. FIG. 39 is a view showing a condition in which a bearing is mounted on the nut body, and FIG. 40 is a view in which the construction of FIG. 39 is cut along the line XXXX-XXXX, and is seen in a direction of arrows.

As shown in FIGS. 35 and 37, part of a circulating passage 3145c of the body 3145a is open (3145j) radially outwardly. In the body 3045a shown in FIG. 33, the circulating passage 3045c must be formed by a long drill, and there is a problem that the processing time is long. On the other hand, in this embodiment, the slot-like opening 3145j can be easily formed by a groove-forming processing using an end mill or the like, and therefore the processing time is short, and the cost can be reduced. Incidentally, a threaded portion 3145k formed on an outer peripheral surface of the nut 3145, a female screw groove 3145f, those portions interconnecting the circulating passage 3145c and the female screw groove 3134f, etc., can be easily formed in the axial direction as in conventional examples.

When the body 3145a is mounted in the electric power steering apparatus as shown in FIGS. 39 and 40, the opening 3145j is covered with the bearing 3027 (held against a step portion 3145h) from the radially-outward side to form a circulating passage closed over the entire periphery thereof, and therefore balls 3065 will not slip out to the exterior via the opening 3145j. Namely, it is not necessary to use a separate member for covering the opening 3145j, and the reduction of the number of the parts and the reduction of the cost can be achieved.

However, since the opening 3145j is formed, there is a fear that the rolling movement of the balls 3065 passing through the circulating passage 3145c may be affected. This problem is solved in the following modified example.

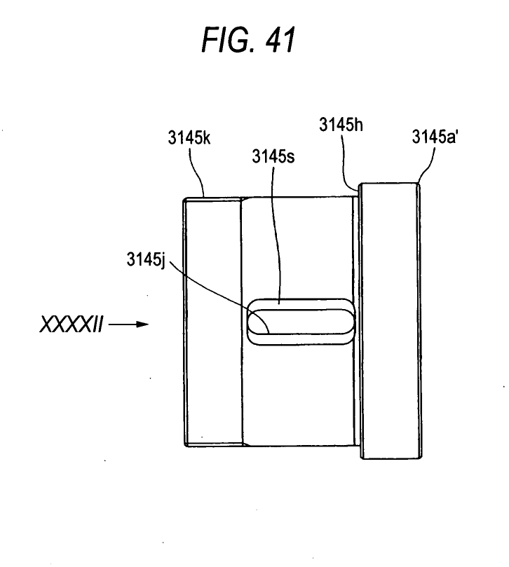

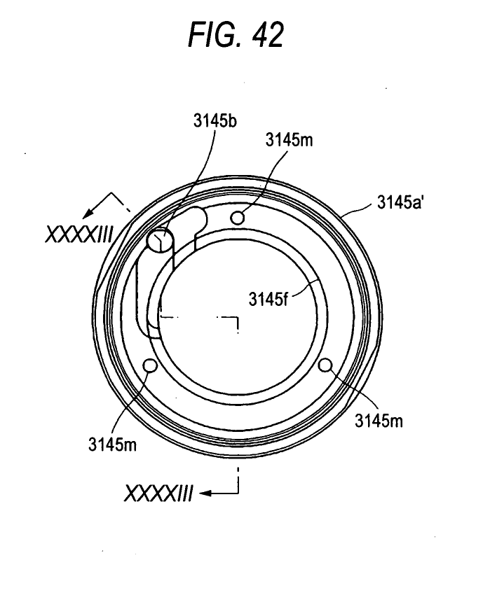

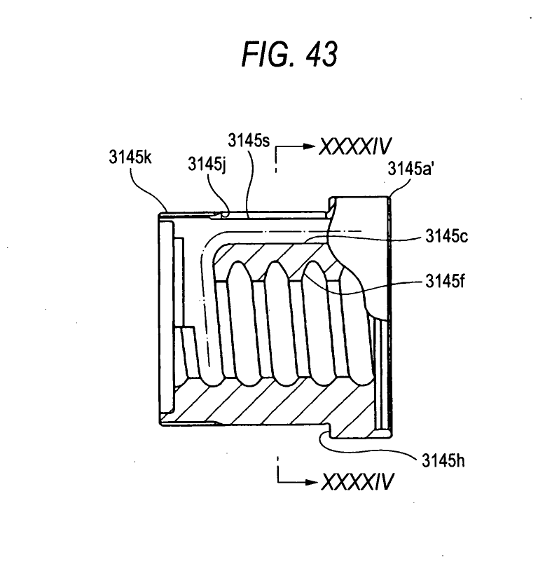

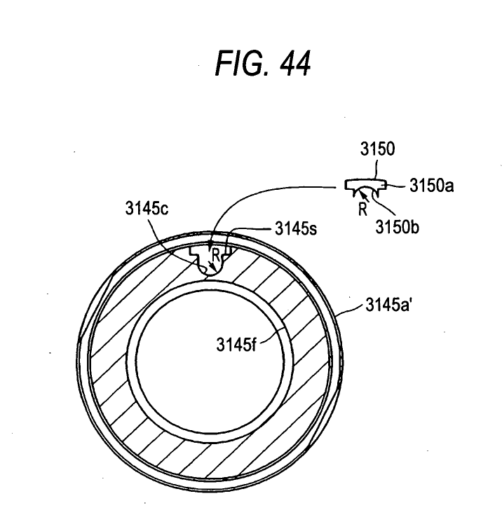

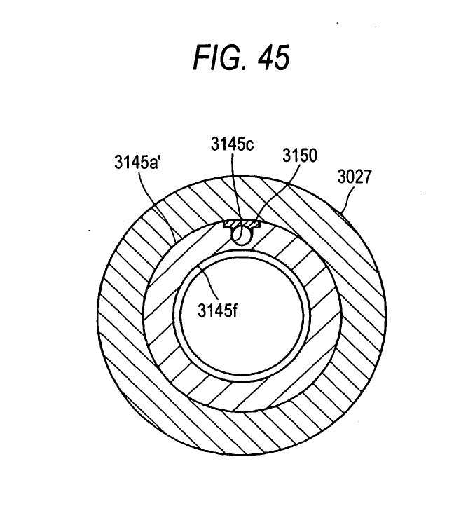

FIG. 41 is a top plan view of a body of a nut of the modified example, FIG. 42 is a view in which the nut body shown in FIG. 41 is seen in a direction of arrow XXXXII, FIG. 43 is a view in which the nut body shown in FIG. 42 is cut along the line XXXXIII-XXXXIII, and is seen in a direction of arrows, FIG. 44(a) is a view in which the nut body shown in FIG. 43 is cut along the line XXXXIV-XXXXIV, and is seen in a direction of arrows, and FIG. 44(b) is a front-elevational view of a lid member which is to be mounted on the nut body. FIG. 45 is a view showing a condition in which a bearing is mounted on the nut body, and is a cross-sectional view similar to FIG. 40.

This modified example differs from the embodiment shown in FIGS. 35 to 40 in that there is provided the lid member 3150 covering (shielding) an opening 3145j and that an opening step portion 3145s for mounting this lid member 3150 is formed at the body 3145a′. With respect to common constructions, identical reference numerals will be applied, and explanation thereof will be omitted.

Describing this modified example more specifically, the opening step portion 3145s is formed at the body 3145a′ at the perimeter of the opening 3145j, and is disposed one step lower than the outer periphery of the body as shown in FIGS. 41 and 44. The lid member 3150 includes a flange portion 3150a which is attached to the opening step portion 3145s to prevent the lid member from dropping into the opening 3145j, and a cylindrical groove 3150b formed in one surface of the flange portion 3150a. A cross-sectional shape (radius R) of the cylindrical groove 3150b corresponds to a cross-sectional shape (radius R) of a circulating groove 3145c, and preferably a cross-section formed by these has a generally round shape with a radius R. Namely, a space formed by the circulating groove 3145c and the lid member 3150 defines a cylindrical hole formed as by a drill. Furthermore, the flange portion 3150a of the lid member 3150 has such dimensions that the outer surface of the lid member 3150, attached to the body 3145a′, is disposed flush with the outer peripheral surface of the body 3145a′.

When the body 3145a′ having the lid member 3150 attached thereto as shown in FIG. 45 is mounted in an electric power steering apparatus, the flange portion 3150a of the lid member 3150 is held between the opening step portion 3145s and a bearing 3027, and therefore circulating balls 3065, when passing through the circulating groove 3145c, will not slip out to the exterior via the opening 3145j, and a step portion formed as a result of providing the opening 3145j is eliminated by the cylindrical grove 3150b of the lid member 3150, and therefore the rolling of the balls 3065 becomes smooth, and abnormal sounds and vibrations can be suppressed. And besides, the lid member 3150 is prevented by the bearing 3027 from being separated from the body 3145a′.

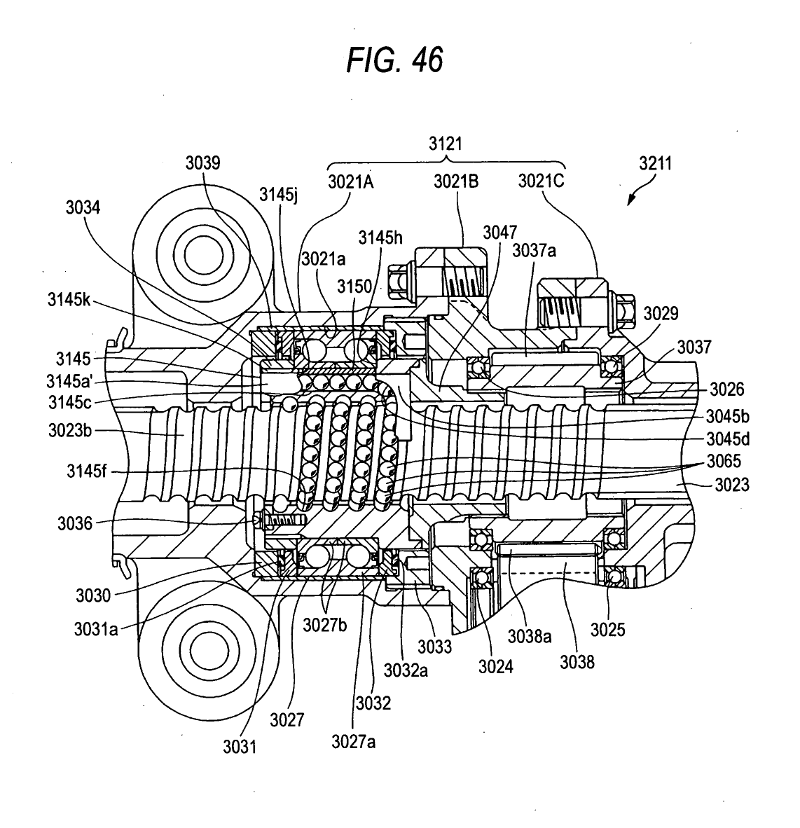

FIG. 46 is a cross-sectional view showing an electric power steering apparatus 3211 employing the modified example shown in FIGS. 41 to 45. This embodiment differs from the embodiment shown in FIGS. 31 to 33 only in that the opening 3145j and the lid member 3150 are provided, and therefore with respect to common constructions, identical reference numerals will be applied, and explanation thereof will be omitted.

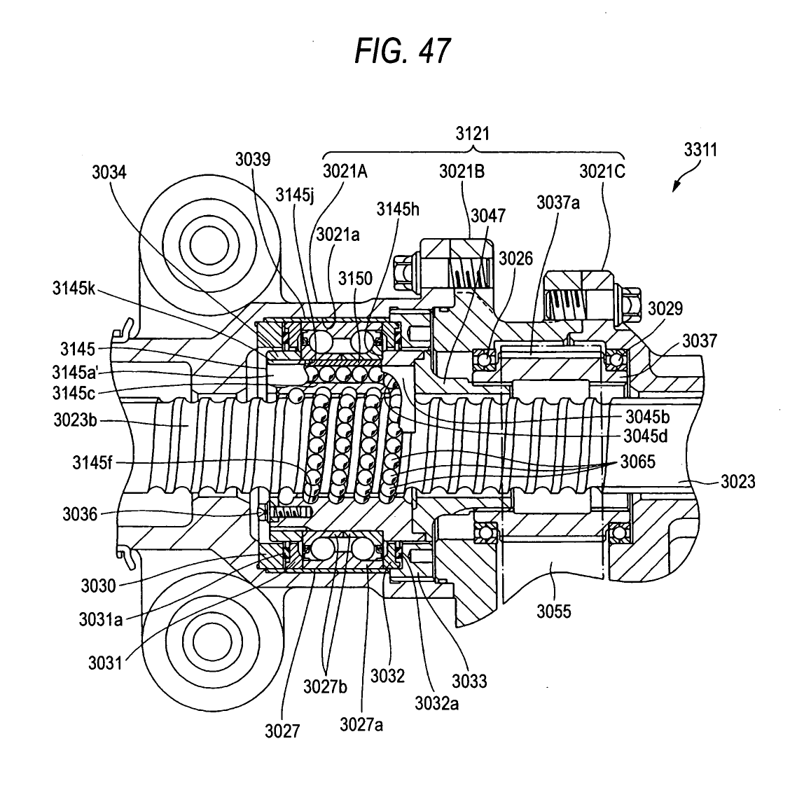

FIG. 47 is a cross-sectional view of an electric power steering apparatus 3311 of a nineteenth embodiment. In this embodiment, only those points different from the embodiment shown in FIG. 46 will be described, and with respect to common constructions, identical reference numerals will be applied, and explanation thereof will be omitted.

In this embodiment, instead of omitting the intermediate shaft, there is provided a toothed belt 3055 for transmitting power to a gear portion 3037a of a driven shaft 3037. Therefore, power from an electric motor not shown is transmitted to the driven shaft 3037 via the toothed belt 3055, and a nut 3145 connected thereto also rotates, and therefore power of the electric motor can be transmitted to a screw shaft 3023. Incidentally, a chain may be used instead of the toothed belt. Such a belt or such a chain can be used also in the embodiments of FIGS. 31 and 34.

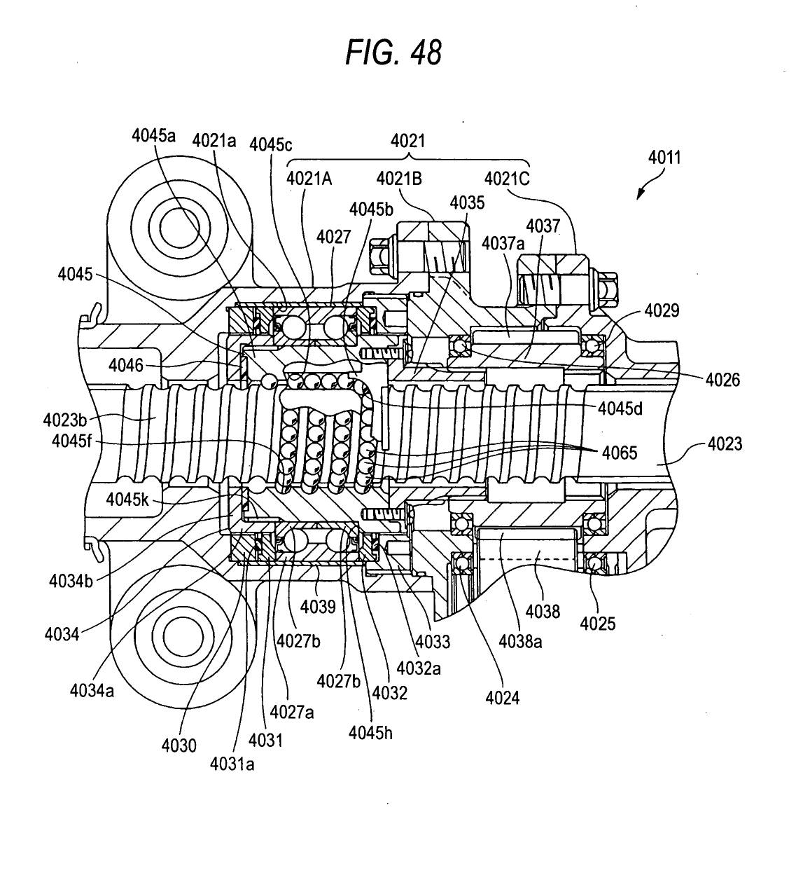

FIG. 48 is a cross-sectional view of an important portion of an electric power steering apparatus of a twentieth embodiment. In FIG. 48, the electric power steering apparatus 4011 has a housing 4021 fixed to a vehicle body not shown. The housing 4021 is divided into three sections in FIG. 48, and comprises members 4021A, 4021B, 4021C fastened together into a unitary form by bolts. A rack shaft 4023 extends horizontally through the housing 4021, and is supported so as to be moved in an axial direction. Although not shown, a pinion is formed at a lower end of an input shaft connected to a steering wheel, and is in mesh with rack teeth of the rack shaft 4023, and the rack shaft 4023 is moved left and right in the drawings by rotation of the input shaft. Opposite ends of the rack shaft 4023 are connected to a tie rod (not shown) of a steering mechanism.

An electric motor (not shown) is mounted on the housing 4021 in such a manner that its axis is parallel to the rack shaft 4023. Power of the electric motor is transmitted to an intermediate shaft 4038 only part of which is shown in FIG. 48. The intermediate shaft 4038 is rotatably supported on the housing 4021 by bearings 4024, 4025, and has an intermediate gear portion 4038a at a portion thereof interposed between the bearings 4024, 4025.

A nut 4045 is disposed around the periphery of the rack shaft 4023, and is rotatably supported on the housing 4021 by a double row angular contact ball bearing 4027. This will now be described more specifically. A thin-wall cylindrical sleeve 4039 is fittingly disposed within an inner hole 4021a of the member 4021A of the housing 4021. And, a ring-like member 4030, a first buffer member 4031, an outer ring 4027a of the double row angular contact ball bearing 4027 and a second buffer member 4032 are arranged in this order from a bottom surface (the left side in FIG. 48) of the inner hole 4021a, and are fixed by a lock member 4033 threadedly engaged with the member 4021A. The first buffer member 4031 has an elastic body 4031a abutting against the ring-like member 4030. And, the second buffer member 4032 has an elastic body 4032a abutting against the lock member 4033. By elastic deformation of the elastic bodies 4031a, 4032a, the double row angular contact ball bearing 4027 can move together with the nut 4045 in the axial direction within a limited range. The outer ring 4027a is fitted in an inner peripheral surface of the sleeve 4039.

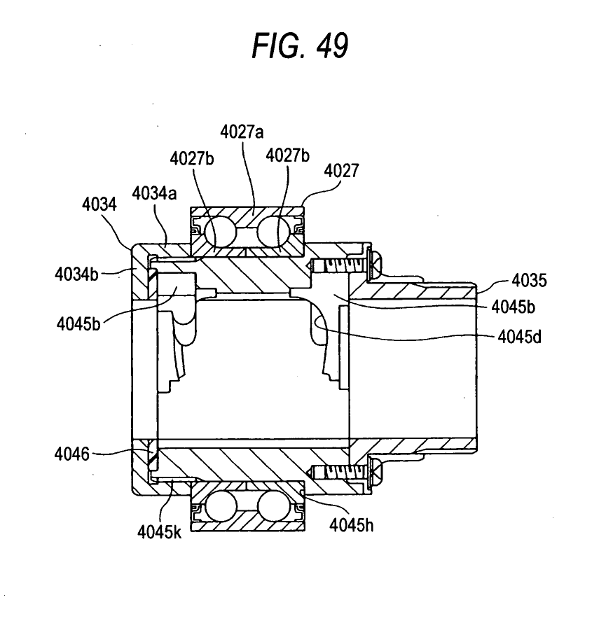

FIG. 49 is a cross-sectional view showing the nut of the electric power steering apparatus of this embodiment in an assembled condition. An inner ring 4027b, 4027b of the double row angular contact ball bearing 4027, which is divided in two sections juxtaposed in the axial direction, is fitted on an outer peripheral surface of the nut 4045, and its right end (in the drawings) abuts against an outer peripheral step portion 4045h formed at that portion of the nut 4045 near to a right end thereof. And, the left end (in the drawings) of the inner ring 4027b, 4027b abuts against a right end of a threaded member 4034 (which is fastening means for fixing the bearing), so that a preload is applied to the inner ring. The threaded member 4034 includes a cylindrical portion 4034a threaded on a threaded portion 4045K formed on the outer peripheral surface of the nut 4045, and a flange portion 4034b extending radially inwardly from a left end of the cylindrical portion 4034a. The preload can be adjusted by the amount of threading of the cylindrical portion 4034a. The flange portion 4034b abuts against a left deflector 4045b (in the drawings) through a ring-like elastic body (made of rubber or a resin) 4046 to fix this deflector. The elastic body 4046, when pressed, can be elastically deformed within a certain range, and therefore if the threaded member 4034 is tightened, giving a preference to the preloading of the double row angular contact ball bearing 4027, this will not offer any particular problem.

In FIG. 48, a right deflector 4045b (in the drawings) of the nut 4045, disposed radially inwardly of the lock member 4033, is fixed by a spline member 4035 screw-fastened to the right end of the nut 4045. The spline member 4035 is spline-connected to a driven gear 4037 disposed in spaced relation to the nut 4045 in the axial direction, thereby enabling a relative movement between the nut 4045 and the driven gear 4037 so that the buffer members 4031 and 4032 can achieve the buffering effect as when an impact force develops in a power transmission path.

The driven gear 4037 is rotatably supported at its opposite ends on the housing 4021 by bearings 4026, 4029, and has a driven gear portion 4037a in mesh with the intermediate gear portion 4038a. The intermediate gear portion 4038a and the driven gear portion 4037a form a gear pair. Incidentally, the nut 4045, etc., can be mounted from the right side in the drawings in a condition in which the members 4021A, 4021B of the housing 4021 are removed.

The nut 4045 includes a central body 4045a of a hollow cylindrical shape, and the deflectors 4045b provided respectively at opposite ends thereof. The body 4045a forms a circulating passage 4045c extending therethrough in an axial direction. Each deflector 4045b forms a pick-up piece 4045d which picks up rolling balls 4065 in a tangential direction of a rolling passage and also in a direction of a lead angle thereof to return the balls to the circulating passage 4045c.

A male screw groove 4023b is formed in part of the outer peripheral surface of the rack shaft 4023 integral with the screw shaft (A separate part may be connected). The nut 4045 is disposed around the periphery of the male screw groove 4023b, and a female screw groove 4045f is formed in the inner peripheral surface of the body 4045a opposed to the male screw groove 4023b. A number of balls (rolling members) 4065 are rollably disposed within a spiral space (rolling passage) formed by the male screw groove 4023b and the female screw groove 4045f. The rack shaft (screw shaft) 4023, the nut 4045 and the balls 4065 form a ball screw mechanism (power transmission mechanism).

The operation of this embodiment will be explained. Although not shown, when the driver rotates the steering wheel, its rotational force is transmitted to the input shaft. When the input shaft rotates, the rack teeth pinion-meshed therewith are pushed, and the rack shaft 4023 is moved in the axial direction to drive the steering mechanism (not shown) via the tie rod, thereby effecting the steering of vehicle wheels.

At this time, a torque sensor not shown detects a steering torque, and in accordance with its amount, a CPU not shown supplies electric power to the electric motor, and therefore the driven gear portion 4037a meshed via the intermediate gear portion 4038a is rotated at a predetermined reduction ratio. Therefore, the nut 4045 connected to the driven gear 4037 via the spline member 4035 also rotates, and its rotational motion is converted into an axial movement of the rack shaft 4023 via the balls 4065. The ball 4065, rolled to one end of the rolling passage, is picked up by the deflector 4045b, and is returned to the other end through the circulating passage 4045c. An assist steering force can be outputted, using the axial force of the rack shaft 4023.

In the electric power steering apparatus 4011 of this embodiment, the left deflector 4045b (in the drawings) is fixed to the nut 4045, using the threaded member 4034 fixing the double row angular contact ball bearing 4027 supporting the nut 4045, and therefore the number of the parts required for the assembling is reduced, and also the assembling becomes easy. And besides, the elastic body 4046 is interposed between the deflector 4045b and the threaded member 4034, and therefore vibrations and noises, developing when the balls 4065 impinge on the deflector 4065 during the operation, can be reduced by this elastic body 4046.

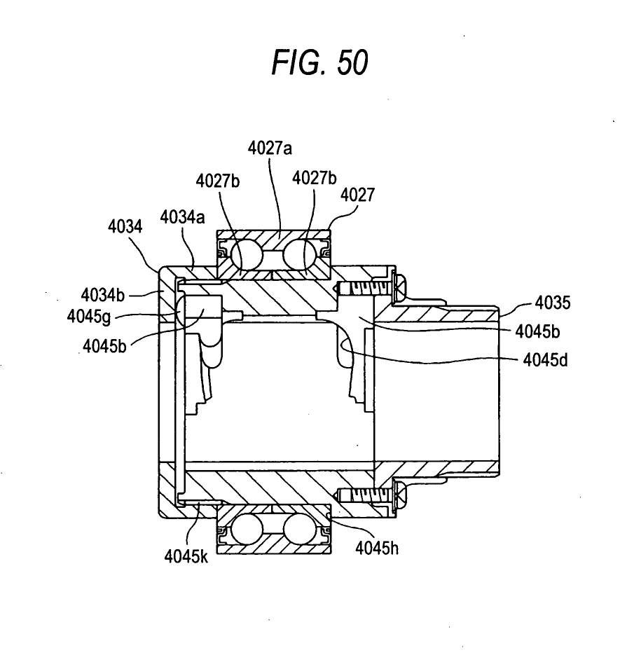

FIG. 50 is a cross-sectional view showing a nut of an electric power steering apparatus of a twenty-first embodiment in an assembled condition. In this embodiment, only those points different from the embodiment shown in FIGS. 48 and 49 will be described, and with reference to common constructions, identical reference numerals will be applied, and explanation thereof will be omitted.

In this embodiment, instead of omitting the elastic body, a semi-spherical projection 4045g formed on a deflector 4045b is held against a flange portion 4034b of a threaded member 4034. The projection 4045g, when pressed, can be elastically deformed within a certain range, and therefore preferably, this projection is formed into a slightly large size, and the mounting is effected while elastically deforming this projection when applying a preload to a double row angular contact ball bearing 4027.

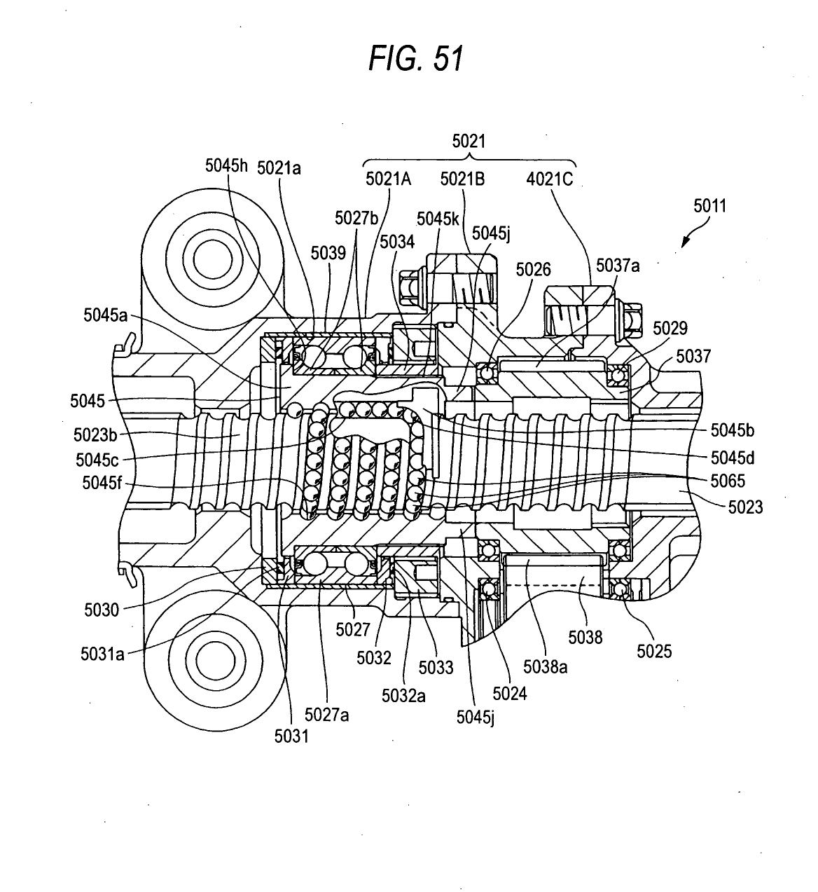

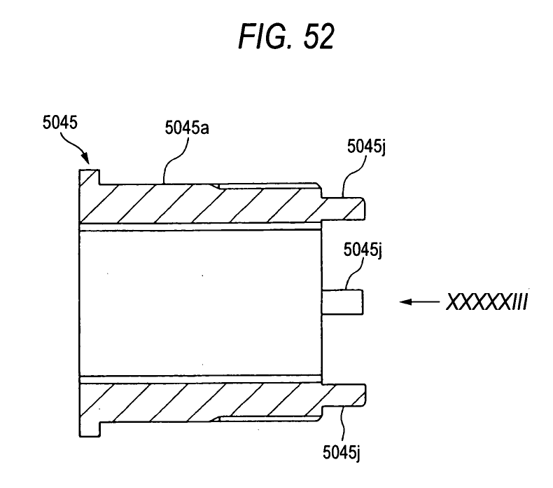

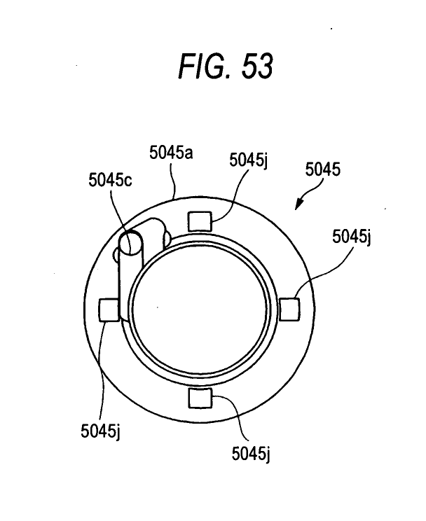

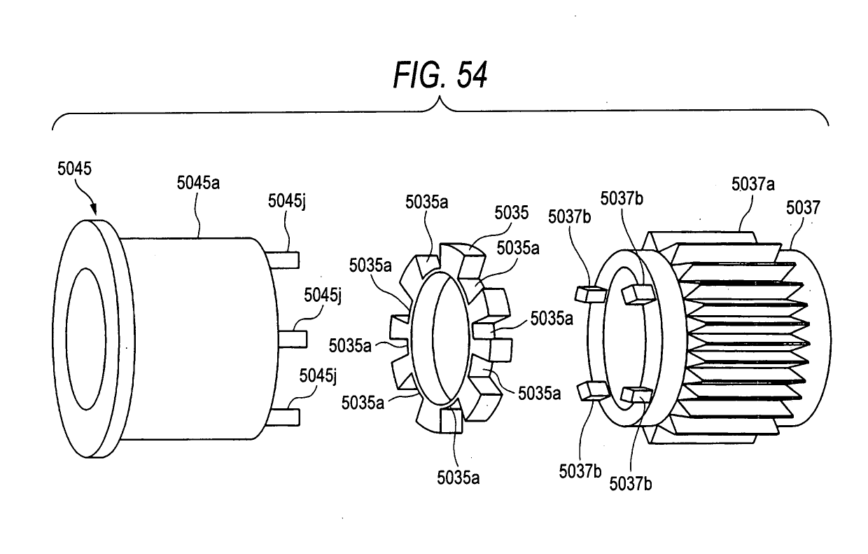

FIG. 51 is a cross-sectional view of an important portion of an electric power steering apparatus of a twenty-second embodiment. FIG. 52 is a cross-sectional view showing a nut alone, FIG. 53 is a view in which the nut of FIG. 52 is seen in a direction of arrow XXXXXIII, and FIG. 54 is an exploded perspective view of the nut and a driven gear.

In FIG. 51, the electric power steering apparatus 5011 has a housing 5021 fixed to a vehicle body not shown. The housing 5021 is divided into three sections in FIG. 51, and comprises members 5021A, 5021B, 5021C fastened together into a unitary form by bolts. A rack shaft 5023 extends horizontally through the housing 5021, and is supported so as to be moved in an axial direction. Although not shown, a pinion is formed at a lower end of an input shaft connected to a steering wheel, and is in mesh with rack teeth of the rack shaft 5023, and the rack shaft 5023 is moved left and right in the drawings by rotation of the input shaft. Opposite ends of the rack shaft 5023 are connected to a tie rod (not shown) of a steering mechanism.

An electric motor (not shown) is mounted on the housing 5021 in such a manner that its axis is parallel to the rack shaft 5023. Power of the electric motor is transmitted to an intermediate shaft 5038 only part of which is shown in FIG. 51. The intermediate shaft 5038 is rotatably supported on the housing 5021 by bearings 5024, 5025, and has an intermediate gear portion 5038a at a portion thereof interposed between the bearings 5024, 5025.

The nut 5045 is disposed around the periphery of the rack shaft 5023, and is rotatably supported on the housing 5021 by a double row angular contact ball bearing 5027. This will now be described more specifically. A thin-wall cylindrical sleeve 5039 is fittingly disposed within an inner hole 5021a of the member 5021A of the housing 5021. And, a ring-like member 5030, a first buffer member 5031, an outer ring 5027a of the double row angular contact ball bearing 5027 and a second buffer member 5032 are arranged in this order from a bottom surface (the left side in FIG. 51) of the inner hole 5021a, and are fixed by a lock member 5033 threadedly engaged with the member 5021A. The first buffer member 5031 has an elastic body 5031a abutting against the ring-like member 5030. And, the second buffer member 5032 has an elastic body 5032a abutting against the lock member 5033. By elastic deformation of the elastic bodies 5031a, 5032a, the double row angular contact ball bearing 5027 can move together with the nut 5045 in the axial direction within a limited range. The outer ring 5027a is fitted in an inner peripheral surface of the sleeve 5039.

An inner ring 5027b, 5027b of the double row angular contact ball bearing 5027, which is divided in two sections juxtaposed in the axial direction, is fitted on an outer peripheral surface of the nut 5045, and its left end (in the drawings) abuts against an outer peripheral step portion 5045h formed at a left end of the nut 5045. And, the right end (in the drawings) of the inner ring 5027b, 5027b abuts against a left end of a threaded member 5034, so that a preload is applied to the inner ring. The threaded member 5034 is threaded on a threaded portion 5045K formed on the outer peripheral surface of the nut 5045. The preload can be adjusted by the amount of threading of the threaded member 5034.

The nut 5045 includes a central body 5045a of a hollow cylindrical shape, and deflectors 5045b (only one of which is shown in FIG. 51) provided respectively at opposite ends thereof. The body 5045a forms a circulating passage 5045c extending therethrough in an axial direction. Each deflector 5045b forms a pick-up piece 5045d which picks up rolling balls 5065 in a tangential direction of a rolling passage and also in a direction of a lead angle thereof to return the balls to the circulating passage 5045c. The screw shaft 5023, the nut 5045 and the balls 5065 form a ball screw mechanism (power transmission mechanism).

In FIG. 52, four square pillar-like projections 5045j are formed on a right end surface of the body 5045a of the nut 5045 at intervals of 90 degrees in a peripheral direction (see FIG. 53), and project in the axial direction (extend from this end surface in the axial direction). As shown in FIG. 53, the circulating passage 5045c is disposed between the two projections 5045j, and the deflector 5045b is attached to this region, and therefore the projections 5045j will not adversely affect the disposition thereof.

In FIG. 51, the hollow driven gear 5037 which is a driven member is rotatably supported at its opposite ends on the housing 5021 by bearings 5026, 5029, and has a driven gear portion 5037a in mesh with the intermediate gear portion 5038a. The intermediate gear portion 5038a and the driven gear portion 5037a form a gear pair. Incidentally, the nut 5045, etc., can be mounted from the right side in the drawings in a condition in which the members 5021A, 5021B of the housing 5021 are removed.

In FIG. 54, four square pillar-like projections 5037b are formed on an end surface of the driven gear 5037 at intervals of 90 degrees in a peripheral direction in opposed relation to the body 5045a of the nut 5045, and project in the axial direction. A ring-like elastic body (made of rubber or a resin) 5035 is disposed between the body 5045a and the driven gear 5037. The elastic body 5035 has eight groove portions 5035a formed at intervals of 45 degrees in a peripheral direction. The groove portions 5035a correspond in configuration to the projections 5045j, 5037b.

At the time of the assembling, the projections 5045j of the body 5045a are arranged to pass through the groove portions 5035a of the elastic body 5035, and also the projections 5037b of the driven gear 5037 are arranged to pass through the remaining groove portions 5035a of the elastic body 5035. Namely, the elastic body 5035 is disposed between the projections 5045j, 5037b alternately arranged in the peripheral direction. Preferably, in order that the buffer members 5031, 5032 can achieve the buffering effect, the projections 5045j are disposed such that their distal ends do not abut against the opposing end surface of the driven gear 5037 with a gap formed therebetween, and also the projections 5037b are disposed such that their distal ends do not abut against the opposing end surface of the body 5045a with a gap formed therebetween.

In FIG. 51, a male screw groove 5023b is formed in part of the outer peripheral surface of the rack shaft 5023 integral with the screw shaft (A separate part may be connected). The nut 5045 is disposed around the periphery of the male screw groove 5023b, and a female screw groove 5045f is formed in the inner peripheral surface of the body 5045a opposed to the male screw groove 5023b. A number of balls (rolling members) 5065 are rollably disposed within a spiral space (rolling passage) formed by the male screw groove 5023b and the female screw groove 5045f.

The operation of this embodiment will be explained. Although not shown, when the driver rotates the steering wheel, its rotational force is transmitted to the input shaft. When the input shaft rotates, the rack teeth pinion-meshed therewith are pushed, and the rack shaft 5023 is moved in the axial direction to drive the steering mechanism (not shown) via the tie rod, thereby effecting the steering of vehicle wheels.

At this time, a torque sensor not shown detects a steering torque, and in accordance with its amount, a CPU not shown supplies electric power to the electric motor, and therefore the driven gear portion 5037a meshed via the intermediate gear portion 5038a is rotated at a predetermined reduction ratio. Therefore, the rotational power is transmitted from the driven gear 5037 to the nut 5045 via the elastic body 5035, and the rotational motion of the nut 5045 is converted into an axial movement of the rack shaft 5023 via the balls 5065. The ball 5065, rolled to one end of the rolling passage, is picked up by the deflector 5045b, and is returned to the other end through the circulating passage 5045c. An assist steering force can be outputted, using the axial force of the rack shaft 5023.

In the electric power steering apparatus 5011 of this embodiment, the axially-extending projections 5045j are formed on the end surface of the body 5045a of the nut 5045, and power of the electric power is transmitted via these projections, and therefore the power transmission can be effected without increasing the outer diameter of the nut 5045. And besides, the power is directly transmitted to the body 5045a, and therefore any power is not transmitted to the deflector 5045b, and deformation and breakage due to the power transmission will not occur.

Furthermore, the power is transmitted from the projections 5037b of the driven gear 5037 to the projections 5045j via the elastic body, and therefore as compared with the case where the projections 5045j and 5037j directly abut against each other, the generation of striking sounds is prevented, and also a jarring motion is eliminated.

Incidentally, the shape of the projections of the nut and the shape of the projections of the driven gear are not limited to the square pillar-shape, but may be a cylindrical shape or a pyramid-shape. Furthermore, there may be provided recesses axially indented from the end surface of the nut, and the projections of the driven gear may be engaged in these recesses. In contrast, similar recesses may be formed in the driven gear, and the projections of the nut may be engaged in these recesses. For transmitting power from the electric motor to the nut, a toothed belt or a chain may be used instead of the gear pair.

Although the present invention has been described above in detail with reference to the embodiments, the present invention should not be construed as being limited to the above embodiments, and suitable changes and improvements can, of course, be made in so far as its subject matter is not spoiled. The present invention can be applied to a so-called steer-by-wire (SBW) type steering mechanism in which a steering wheel and a rack shaft are not mechanically connected together, a rear wheel steering mechanism used in a 4-wheel steering (4WS) vehicle, etc.

### INDUSTRIAL APPLICABILITY

The present invention is suitably used as an electric power steering apparatus for a vehicle.

1. An electric power steering apparatus comprising:
an electric motor;
a rack shaft connected to a steering mechanism; and
a power transmission mechanism for transmitting power from the electric motor to the rack shaft, and the power transmission mechanism comprising:
a screw shaft which is connected to or formed integrally with the rack shaft, and has a male screw groove;
a nut which is disposed on a periphery of the screw shaft, and has a female screw groove; and
a plurality of rolling members which roll in a rolling passage formed between the male screw groove and the female screw groove, wherein
the nut comprises:
a body having an axially-extending circulating passage for the rolling members; and
deflectors which are provided respectively at opposite ends of the body, and pick up the rolling members, rolling in the rolling passage, in a tangential direction of the rolling passage and also in a direction of a lead angle thereof to return the rolling members to the circulating passage.

2. The electric power steering apparatus according to claim 1, wherein the nut has a reception portion for receiving power transmitted from the electric motor, and the reception portion is disposed radially outwardly of the rolling passage.

3. The electric power steering apparatus according to claim 2, wherein the reception portion is a gear portion formed on an outer peripheral surface of the nut.

4. The electric power steering apparatus according to claim 3, wherein the gear portion is in mesh with another gear.

5. The electric power steering apparatus according to claim 3, wherein the gear portion is engaged with a toothed belt.

6. The electric power steering apparatus according to any one of claims 1 to 5, wherein
the deflector is fixed to the nut by using an annular fixing member press-fitted in the nut,
the fixing member has a female serration portion engaged with a male serration portion of an external member, and
the power transmission is performed via an engagement between the male serration portion and the female serration portion.

7. An electric power steering apparatus comprising:
an electric motor;
a rack shaft connected to a steering mechanism; and
a power transmission mechanism for transmitting power from the electric motor to the rack shaft, and the power transmission mechanism comprising:
a screw shaft which is connected to or formed integrally with the rack shaft, and has a male screw groove;
a nut which is disposed on a periphery of the screw shaft, and has a female screw groove;
a plurality of rolling members which roll in a rolling passage formed between the male screw groove and the female screw groove; and
a sleeve having a reception portion for receiving power transmitted from the electric motor, wherein
the nut is inserted in and fixed to the sleeve with the reception portion disposed radially outwardly of the rolling passage, and rotates together with the sleeve.

8. The electric power steering apparatus according to claim 7, wherein the nut comprises:
a body having an axially-extending circulating passage for the rolling members; and
deflectors which are provided respectively at opposite ends of the body, and pick up the rolling members, rolling in the rolling passage, in a tangential direction of the rolling passage and also in a direction of a lead angle thereof to return the rolling members to the circulating passage.

9. The electric power steering apparatus according to claim 7 or 8, wherein the nut is fitted in and fixed to the sleeve.

10. The electric power steering apparatus according to claim 7 or 8, wherein the nut is serration connected to the sleeve.

11. The electric power steering apparatus according to claim 7 or claim 8, wherein an elastic body is interposed between the nut and the sleeve.

12. The electric power steering apparatus according to claim 7 or 8, wherein
a convex portion is formed on an outer peripheral surface of the nut,
a concave portion is formed in an inner peripheral surface of the sleeve, and
the nut is engaged in the sleeve in such a manner that the convex portion is engaged with the concave portion.

13. The electric power steering apparatus according to claim 12, wherein at least part of the convex portion is disposed radially outwardly of the circulating passage of the body.

14. The electric power steering apparatus according to claim 12 or 13, wherein a buffer member is disposed between the convex portion and the concave portion in a peripheral direction.

15. The electric power steering apparatus according to claim 7 or 8, wherein
each of the nut and the sleeve has axially-extending projections, and
a first buffer body is disposed between the projections of the nut and the projections of the sleeve.

16. The electric power steering apparatus according to claim 7 or 8, wherein one of the nut and the sleeve has axially-extending projections, and the other has recesses engaged respectively with the projections.

17. The electric power steering apparatus according to claim 16, wherein a first buffer body is disposed between the projections and the recesses.

18. The electric power steering apparatus according to any one of claims 15 to 17, wherein a gap is formed between the nut and the sleeve, which becomes small when the nut and the sleeve are relatively moved in a direction to compress the first buffer body.

19. The electric power steering apparatus according to any one of claims 7 to 18, further comprising a threaded member threaded in the inner periphery of the sleeve,
wherein a second buffer body is disposed between the threaded member and the nut.

20. The electric power steering apparatus according to claim 19, wherein a gap is formed between the nut and the threaded member, which becomes small when the nut and the sleeve are relatively moved in a direction to compress the second buffer body.

21. The electric power steering apparatus according to claim 7 or 8, wherein the nut and the sleeve are connected together by a key, and rotate integrally.

22. The electric power steering apparatus according to any one of claims 7 to 21, wherein the reception portion is a gear portion formed on an outer peripheral surface of the sleeve.

23. The electric power steering apparatus according to claim 22, wherein the gear portion is in mesh with another gear.

24. The electric power steering apparatus according to claim 22, wherein the gear portion is engaged with a toothed belt.

25. An electric power steering apparatus comprising:
an electric motor;
a rack shaft connected to a steering mechanism; and
a power transmission mechanism for transmitting power from the electric motor to the rack shaft, and the power transmission mechanism comprising:
a screw shaft which is connected to or formed integrally with the rack shaft, and has a male screw groove;
a nut which is disposed on a periphery of the screw shaft, and has a female screw groove; and
a plurality of rolling members which roll in a rolling passage formed between the male screw groove and the female screw groove, wherein
the nut comprises:
a body having an axially-extending circulating passage for the rolling members, and
deflectors which are provided respectively at opposite ends of the body, and pick up the rolling members, rolling in the rolling passage, in a tangential direction of the rolling passage and also in a direction of a lead angle thereof to return the rolling members to the circulating passage, and
power of the electric motor is transmitted to the nut via a fixing member fixing the deflector to the nut.

26. The electric power steering apparatus according to claim 25, wherein the deflector is pressed against the nut by an end surface of the fixing member.

27. The electric power steering apparatus according to claim 25 or claim 26, wherein the nut and the fixing member are positioned by a spigot joint.

28. An electric power steering apparatus according to any one of claims 25 to 27, wherein at least part of the circulating passage is formed by applying a groove-forming processing to the body in a radial direction.

29. The electric power steering apparatus according to claim 28, wherein a bearing is disposed radially outwardly of the formed groove.

30. The electric power steering apparatus according to claim 29, wherein a lid member covering at least part of the circulating passage is disposed between the groove and the bearing.

31. An electric power steering apparatus comprising:
an electric motor;
a rack shaft connected to a steering mechanism; and
a power transmission mechanism for transmitting power from the electric motor to the rack shaft, and the power transmission mechanism comprising:
a screw shaft which is connected to or formed integrally with the rack shaft, and has a male screw groove;
a nut which is disposed on a periphery of the screw shaft, and has a female screw groove; and
a plurality of rolling members which roll in a rolling passage formed between the male screw groove and the female screw groove, wherein
the nut comprises:
a body having an axially-extending circulating passage for the rolling members; and
deflectors which are provided respectively at opposite ends of the body, and pick up the rolling members, rolling in the rolling passage, in a tangential direction of the rolling passage and also in a direction of a lead angle thereof to return the rolling members to the circulating passage, and
the deflector is mounted on the nut by fastening member fixing a bearing supporting the nut.

32. The electric power steering apparatus according to claim 31, wherein an elastic body is interposed between the deflector and the fastening member

33. The electric power steering apparatus according to claim 31, wherein a projection is formed on the deflector, and
the deflector is fixed by holding the fastening member against the projection.

34. An electric power steering apparatus comprising:
an electric motor;
a rack shaft connected to a steering mechanism; and
a power transmission mechanism for transmitting power from the electric motor to the rack shaft, and the power transmission mechanism comprising:
a screw shaft which is connected to or formed integrally with the rack shaft, and has a male screw groove;
a nut which is disposed on a periphery of the screw shaft, and has a female screw groove; and
a plurality of rolling members which roll in a rolling passage formed between the male screw groove and the female screw groove, wherein
the nut comprises:
a body having an axially-extending circulating passage for the rolling members; and
deflectors which are provided respectively at opposite ends of the body, and pick up the rolling members, rolling in the rolling passage, in a tangential direction of the rolling passage and also in a direction of a lead angle thereof to return the rolling members to the circulating passage, and
wherein projections extending from an axially-facing end surface of the body at least in the axial direction or recesses indented from the end surface in the axial direction are formed at the end surface in order to transmit power of the electric motor.

35. The electric power transmission apparatus according to claim 34, wherein an elastic body is provided between a driven member for receiving power from the electric motor and the projections or the recesses.
